(19) United States
(12) Patent Application Publication
(10) Pub. No.: US 2026/0046194 A1
(43) Pub. Date: Feb. 12, 2026

(54) NETWORK ANALYSIS

(71) Applicant: PROMPTLINK COMMUNICATIONS, INC., Oceanside, CA (US)

(72) Inventors: Foad TOWFIQ, Vista, CA (US); Alexander PODAREVSKY, Oceanside, CA (US)

(21) Appl. No.: 19/363,482

(22) Filed: Oct. 20, 2025

Related U.S. Application Data
(63) Continuation-in-part of application No. 18/616,868, filed on Mar. 26, 2024.
(60) Provisional application No. 63/454,907, filed on Mar. 27, 2023.
(60) Provisional application No. 63/569,642, filed on Mar. 25, 2024.
(60) Provisional application No. 63/709,920, filed on Oct. 21, 2024.

(51) Int. Cl. H04L 41/0631

(52) U.S. Cl. CPC H04L 41/0631

(57) ABSTRACT

Various techniques for analyzing data networks with impaired network components, recording network telemetry data, labeling the information, and retrieving the information is described.

### CROSS-REFERENCE TO RELATED APPLICATIONS

This application claims priority to U.S. Provisional Application No. 63/709,920, entitled “Network Performance and Fault Detection, Identification, and Localization”, filed Oct. 21, 2024 and this application is a continuation-in-part of U.S. patent application Ser. No. 18/616,868, entitled “METHODS AND APPARATUS FOR NETWORK ANALYSIS”, filed Mar. 26, 2024, which claims priority to U.S. Provisional Application No. 63/569,642, entitled “METHODS AND APPARATUS FOR NETWORK ANALYSIS,” filed Mar. 25, 2024 and to U.S. Provisional Patent Application Ser. No. 63/454,907, entitled “METHODS AND APPARATUS FOR GENERATING SIMULATED TRAINING DATA”, filed Mar. 27, 2023, the contents of which are hereby incorporated by reference in their entireties for all purposes.

### FIELD

The present disclosure relates generally to the generation, labeling, storage, and retrieval of data corresponding to impaired network components and/the topology of a hybrid fiber coaxial (HFC) network.

### BACKGROUND

Service providers (e.g., operators) provide customers (e.g., subscribers) with services, such as multimedia, audio, video, telephony, data communications, wireless networking, and wired networking. Service providers provide such services by deploying one or more electronic devices at their customers' premises, and then connecting the deployed electronic device to the service provider's network or infrastructure. The deployed electronic devices are often called Customer Premise Equipment (CPE). For example, a cable company delivers media services to customers by connecting an electronic device, such as a set-top box or a cable modem, located at customer's premise to the cable company's network. This CPE is the device that the service provider uses to deliver the service to the customer.

Networks, such as those maintained by service providers or their customers, may have noise caused by impaired network components, which can cause service degradation and customer dissatisfaction. Examples of impaired network components include loose or corroded connectors, damaged cables, and flooded amplifiers. Over time, as the network ages, the severity and number of impaired network components may increase. Service providers face challenges in identifying the type of noise in the network and localizing the noise in the network to fix the impaired network components in a timely manner so as to limit the impacts of service degradation or outage of their customers.

### SUMMARY

Some techniques for identifying impaired network components on a data network are unreliable and/or inaccurate. For example, some techniques do not identify particular types of impaired network components and/or are unable to identify the location where noise caused by the impaired network components is entering into or originating within the network. Other techniques do not prioritize the repair of impaired network components based on the severity of the network degradation and/or the number of affected customers.

In accordance with some embodiments, a method is described. The method comprises: creating a first network condition in a first data network, wherein the first network condition impairs operation of one or more network components of the first data network; while the first network condition impairs the operation of one or more network components of the first data network, recording first telemetry data produced by one or more network components of the first data network; storing the first telemetry data in association with a characterization of the first network condition and topology information about the first data network; creating a second network condition, different from the first network condition, in a second data network that is different from the first data network, wherein the second network condition impairs operation of one or more network components of the second data network; while the second network condition impairs the operation of one or more network components of the second data network, recording second telemetry data produced by one or more network components of the second data network; storing the second telemetry data in association with a characterization of the second network condition the topology information about the second data network; subsequent to storing the first telemetry data and the second telemetry data, receiving a request that includes: topology information about a data network, and a characterization of a network condition that impairs operation of one or more network components of the data network; and in response to receiving the request: in accordance with a determination that the topology information about the data network corresponds to a topology the first data network and that the characterization of the network condition corresponds to the first network condition, outputting information corresponding to the first telemetry data; and in accordance with a determination that the topology information about the data network corresponds to a topology the second data network and that the characterization of the network condition corresponds to the second network condition, outputting information corresponding to the second telemetry data.

In accordance with some embodiments, a non-transitory computer readable storage medium is described. The non-transitory computer-readable storage medium stores one or more programs configured to be executed by one or more processors, the one or more programs including instructions for: creating a first network condition in a first data network, wherein the first network condition impairs operation of one or more network components of the first data network; while the first network condition impairs the operation of one or more network components of the first data network, recording first telemetry data produced by one or more network components of the first data network; storing the first telemetry data in association with a characterization of the first network condition and topology information about the first data network; creating a second network condition, different from the first network condition, in a second data network that is different from the first data network, wherein the second network condition impairs operation of one or more network components of the second data network; while the second network condition impairs the operation of one or more network components of the second data network, recording second telemetry data produced by one or more network components of the second data network; storing the second telemetry data in association with a characterization of the second network condition the topology information about the second data network; subsequent to storing the first telemetry data and the second telemetry data, receiving a request that includes: topology information about a data network, and a characterization of a network condition that impairs operation of one or more network components of the data network; and in response to receiving the request: in accordance with a determination that the topology information about the data network corresponds to a topology the first data network and that the characterization of the network condition corresponds to the first network condition, outputting information corresponding to the first telemetry data; and in accordance with a determination that the topology information about the data network corresponds to a topology the second data network and that the characterization of the network condition corresponds to the second network condition, outputting information corresponding to the second telemetry data.

### BRIEF DESCRIPTION OF THE DRAWINGS

For a better understanding of the various described embodiments, reference should be made to the Detailed Description of Embodiments below, in conjunction with the following drawings in which like reference numerals refer to corresponding parts throughout the figures.

FIG. 1 shows a map illustrating an exemplary data network that includes the different types of network components that can be associated with a suspected point of impairment.

FIG. 2A shows a diagram illustrating a relationship between three components of a noise localization architecture.

FIG. 2B1 shows an exemplary technique for characterizing an impaired network component as a transmission line model, in accordance with some embodiments.

FIG. 2B2 illustrates exemplary S-parameters for a hardline coaxial cable with a broken radial shield, in accordance with some embodiments.

FIG. 2B3 illustrates exemplary S-parameters for a corroded power splitter, in accordance with some embodiments.

FIGS. 2B4-1 and 2B4-2 illustrates exemplary In-Channel Equalizer Frequency Response (ICEFR) graphs for two distinct cable modems on the same network that are affected by a loose splice connector on a hardline coaxial cable, in accordance with some embodiments.

FIGS. 2B5-1 and 2B5-2 illustrate exemplary In-Channel Equalizer Frequency Response (ICEFR) graphs for two distinct cable modems on the same network that are affected by a defective tap, in accordance with some embodiments.

FIGS. 2B6-1 and 2B6-2 illustrate exemplary Full Band Downstream Spectrum graphs for two distinct cable modems on a network that includes a corroded tap, in accordance with some embodiments.

FIG. 2C1 illustrates exemplary maximum, mean and minimum noise spectrums for different frequencies for a noisy LED light, in accordance with some embodiments.

FIG. 2C2 illustrates an exemplary noise spectrum standard deviation for a noisy LED light, in accordance with some embodiments.

FIG. 2C3 illustrates exemplary maximum, mean and minimum noise spectrums for different frequencies for a noisy LED light, in accordance with some embodiments.

FIG. 2C4 illustrates an exemplary noise spectrum standard deviation for a noisy LED light, in accordance with some embodiments.

FIGS. 2C5-2C8 illustrate the mean temporal rate of change and the variability of the rate of change for various noisy LED lights, in accordance with some embodiments.

FIG. 3 shows an exemplary electronic device, in accordance with some embodiments.

FIG. 4 shows an exemplary movable rack capable of supporting multiple network components in a laboratory or testing environment.

FIGS. 5A-5C show schematic views of movable carts configured to model various portions of an HFC data network.

FIGS. 6A-6B show an exemplary movable cart configured to model the network components used to connect a multi-dwelling unit to an HFC data network.

FIG. 7 shows an exemplary operational HFC data network, its location relative to a residential neighborhood and which portions of the exemplary operational network can be simulated by the network components carried by the movable carts depicted in FIGS. 4-5C.

FIG. 8 is a flow diagram illustrating a method for analyzing a data network, in accordance with some embodiments.

FIGS. 9-10 illustrate aspects of example lab setups, in accordance with some embodiments.

FIG. 11 illustrates an example logical diagram of a data network, in accordance with some embodiments.

FIGS. 12A-12B illustrate a flow diagram for storing and retrieving network information, in accordance with some embodiments.

### DETAILED DESCRIPTION OF EMBODIMENTS

The following detailed description sets forth exemplary methods, parameters, and the like. It should be recognized, however, that such description is not intended as a limitation on the scope of the present disclosure, but is instead provided as a description of exemplary embodiments.

In some embodiments, a system for identifying impaired network components on a data network can be trained using training data based solely upon problems occurring on a commercial data network. Unfortunately, real-world data may not occur with the frequency or variety needed to develop a range of training data suitable for training the system to identify a sufficiently wide range of possible problems occurring on the commercial data network. Thoroughly cataloging and identifying the myriad combinations of noise issues that can occur on the commercial data network is a large task and relying solely on readings taken after noise and/or an impaired network component is identified is not typically sufficient to create a large enough repository of data to train the system to identify and troubleshoot potential solutions to fix problems occurring on a cable network.

Furthermore, adding to the problem of limited amounts of data is that there are often multiple sources of noise. There is noise entering the data network from outside (ingress) that by itself can have different sources, such as impulse noise from machines in a nearby factory, noise from street lights and/or power lines. Noise can also occur unintentionally within the data network by an amplifier overload causing non-linear distortion or corrosion in one or more network components generating common path distortion. Network degradation can sometimes be caused by combined noise from ingress and non-linear distortions, such as inter modulation distortions.

One solution to this problem is to model the data network by clustering all of the network components making up a data network onto various racks in a lab environment. This allows for the testing of multiple scenarios without impacting the service quality of an operational data network. One reason similar testing has not previously been done is that gathering all the components together results in any ambient noise affecting one network component also affecting neighboring components to a degree that they would not in a commercial network where components are separated by larger distances of at least 100 to 200 feet. To address this issue, the lab environment can be equipped with multiple Faraday cages that keep the network component or network components being subject to an impairment condition isolated from other network components making up the network. In this way, noise can be applied to the network in a very controlled manner without unintentionally affecting other components.

When the sources of noise introduced to the data network are controlled in a laboratory environment, labeling of the resulting data being collected from the data network can be labeled without the need for technicians to perform in-depth analysis and/or make educated guesses as to what is the actual cause of a particular network degradation because the source of the network degradation is known. This allows for the modeling of quite complex noise scenarios with little to no effort needed to identify a particularly complex impairment scenario.

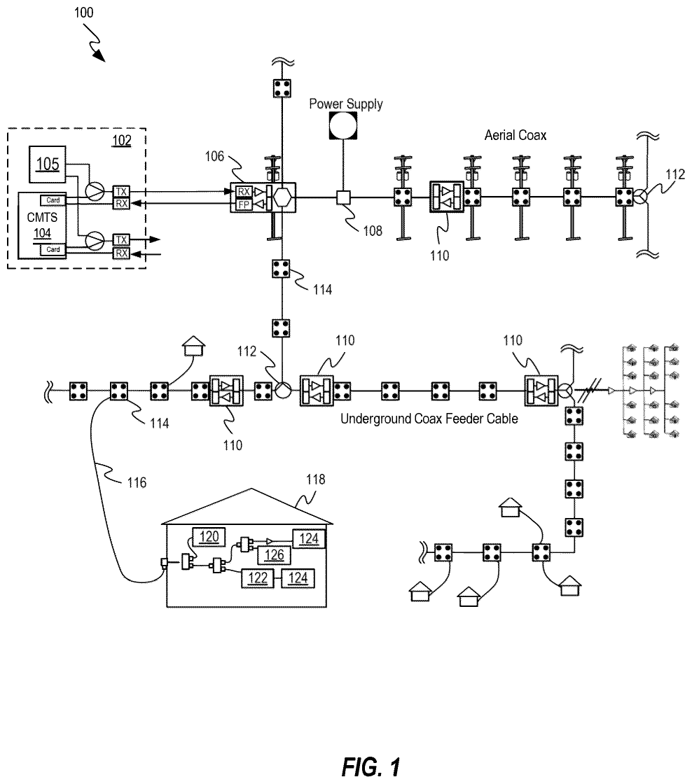

These and other embodiments are discussed below with reference to FIGS. 1-7. Those skilled in the art, however, will readily appreciate that the detailed description given herein with respect to these figures is for explanatory purposes only and should not be construed as limiting.

FIG. 1 shows a network map illustrating different network components used in operating a data network 100. While the teachings of this application could be applied to many different types of data networks, a hybrid fiber coaxial (HFC) data network is used for exemplary purposes only and should not be construed as limiting. An HFC data network generally includes a headend or central office 102 where data network 100 interfaces with a larger internet fiberoptic backbone. Central office 102 includes CUTS 104, which is responsible for handling inbound and outbound data associated with data network 100. Also located at central office 102 is data collection engine 105, which as depicted is capable of transmitting and receiving data and/or configured to transmit and receive data from data network 100. Central office 102 is generally connected by fiber lines to a fiber node 106 by fiber lines that are typically less than 20 km in length and can be configured as above or below ground fiber runs. While only a single fiber node 106 is depicted in FIG. 1 it should be appreciated that data network 100 can include multiple fiber nodes. Coaxial cables leaving fiber node 106 can be distributed above or below ground as illustrated in FIG. 1. The aerial coaxial branch includes a power injector 108, which can be configured to provide additional power for longer coaxial cable runs. Data network 100 can also include amplifiers 110 for increasing the signal strength of traffic travelling along coaxial cable of data network 100. Data network 100 also includes directional couplers 112, which manage the distribution of data along different branches of data network 100. Network taps 114, in addition to connecting the residential and commercial users to the network, allow for checking noise and power levels in various portions of data network 100. Residential or commercial users of data network 100 generally receive their signal by way of a drop cable 116. A particular residence or business, as depicted, can include multiple network components. In particular, exemplary residence 118 includes a cable modem 120, a set top box 122, televisions 124 and telephone 126 that all rely on services provided by data network 100.

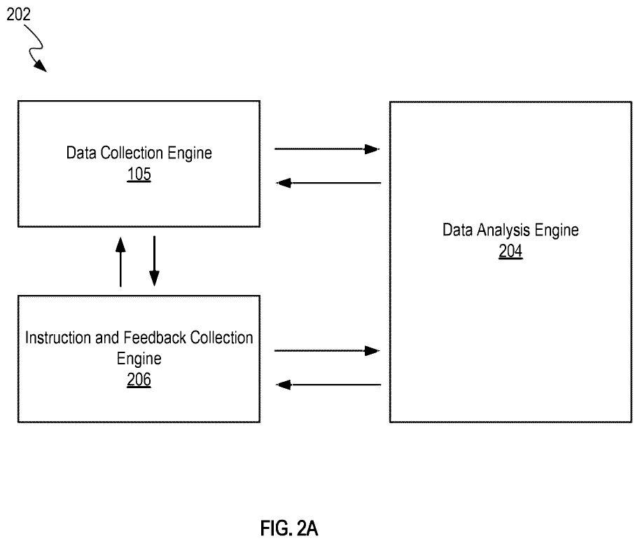

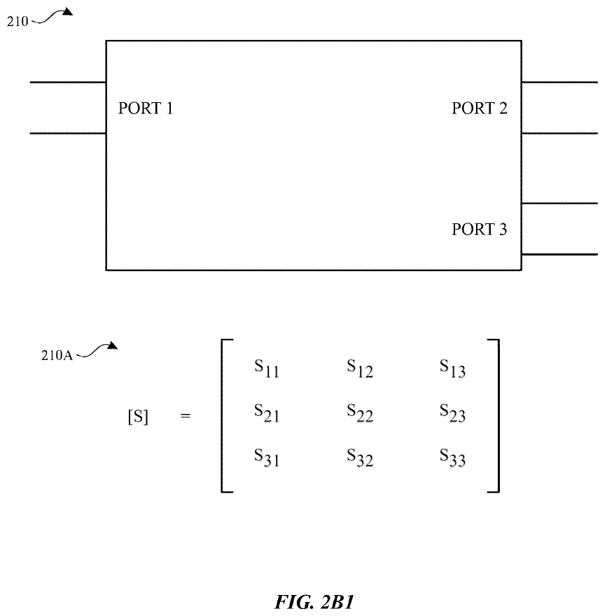

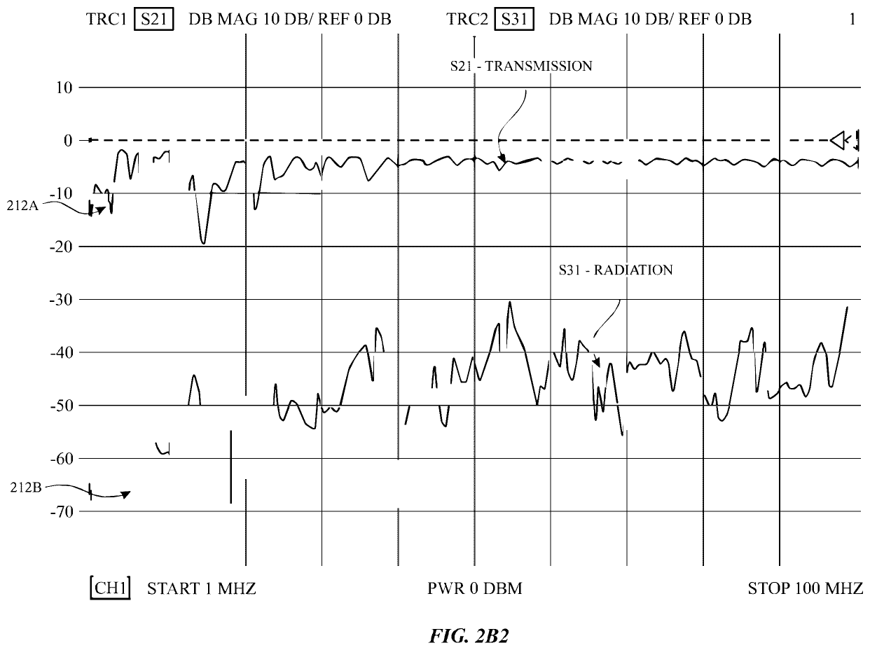

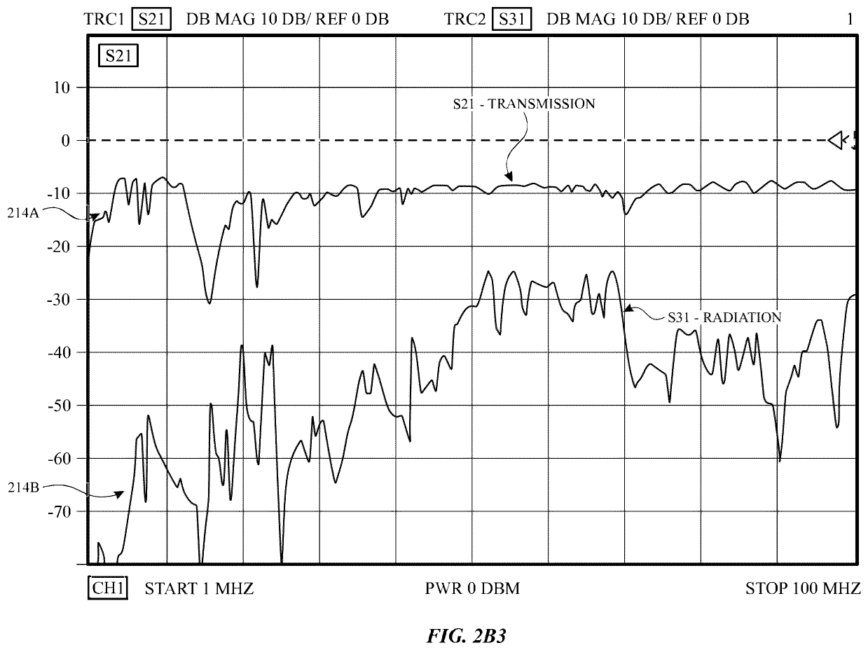

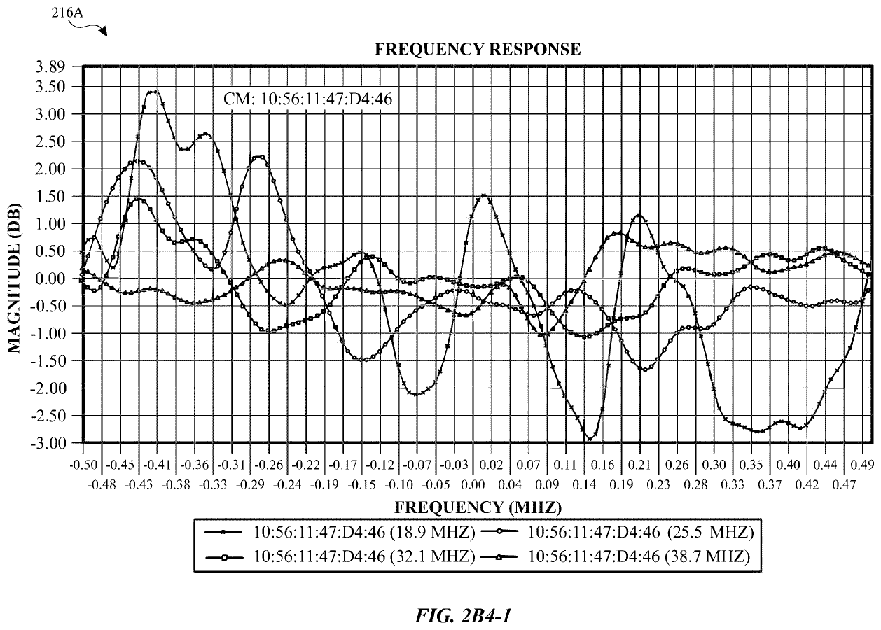

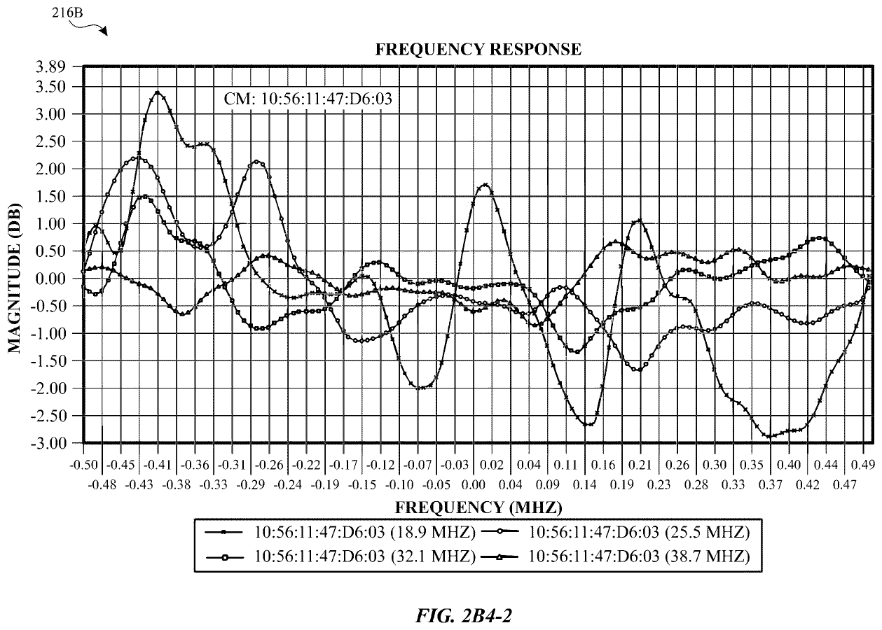

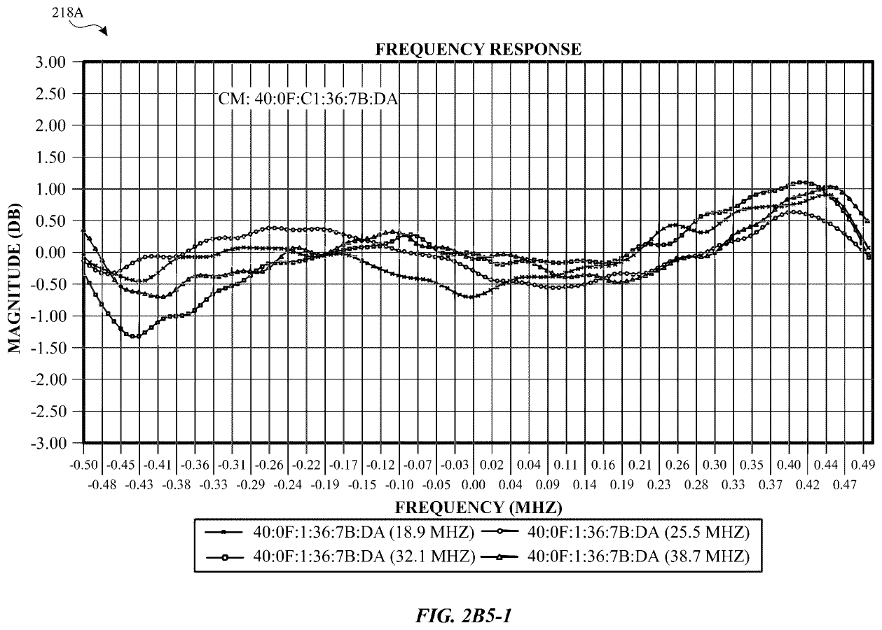

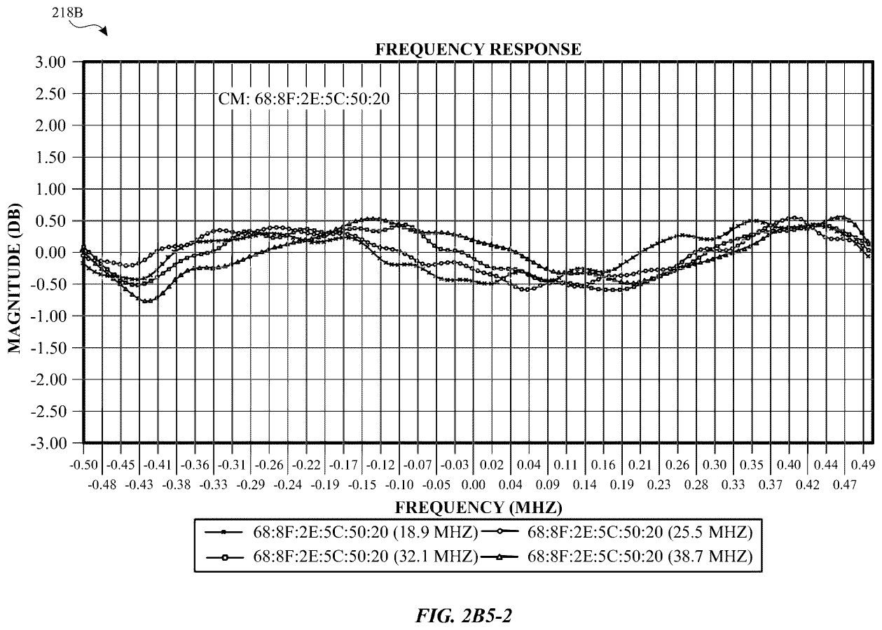

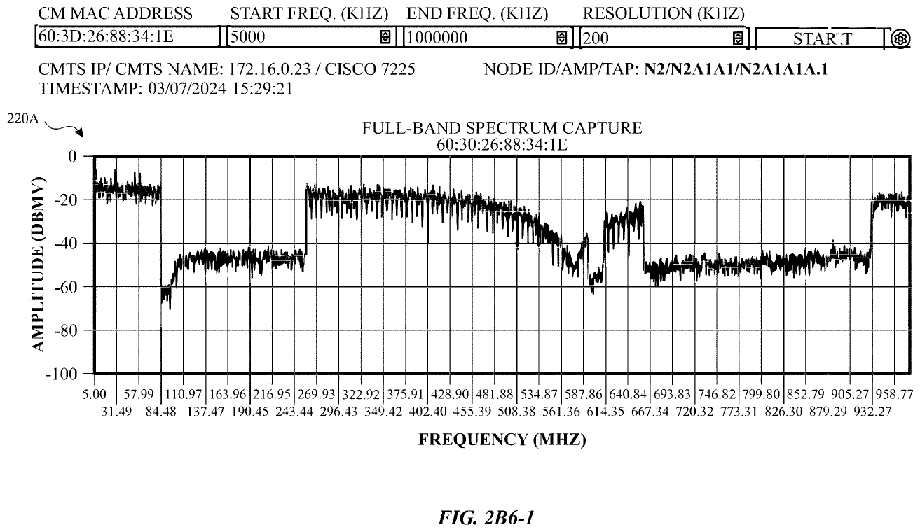

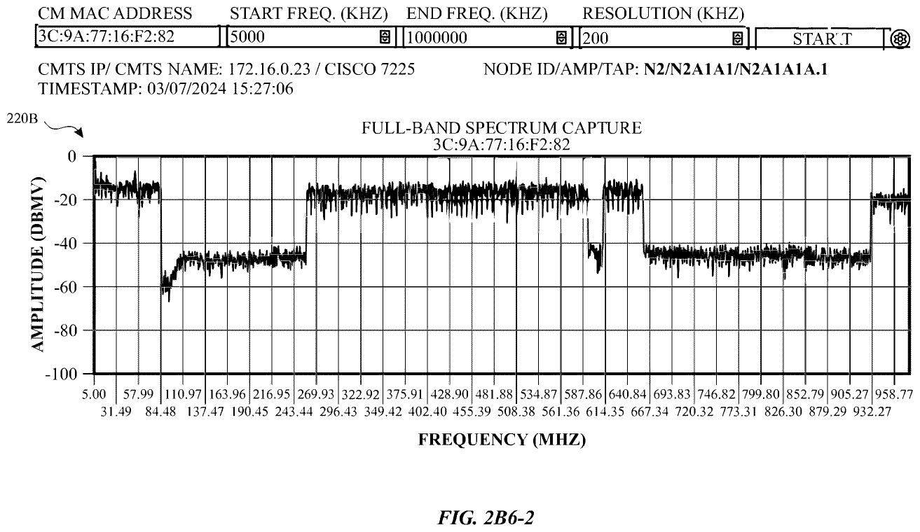

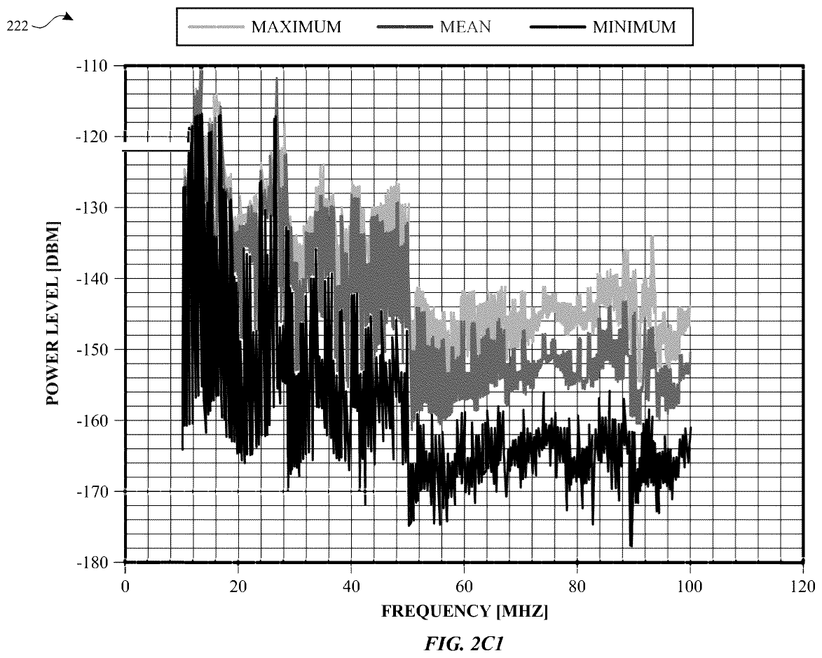

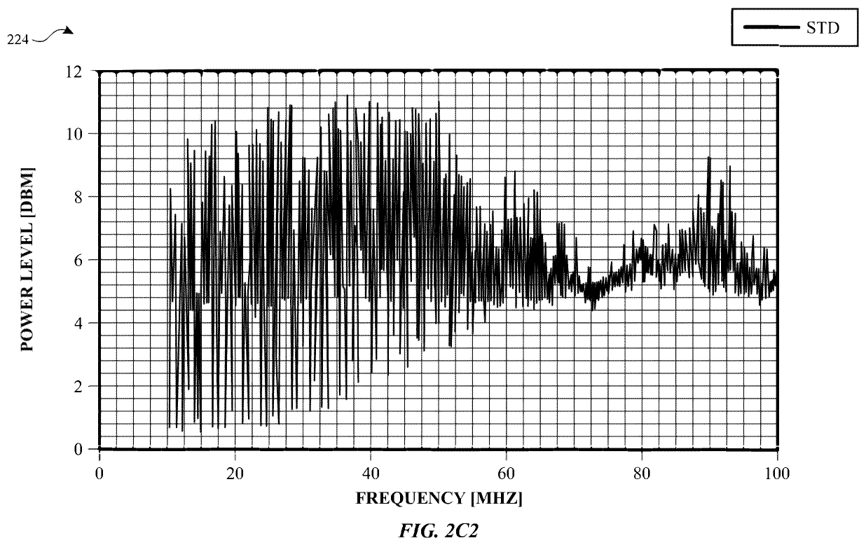

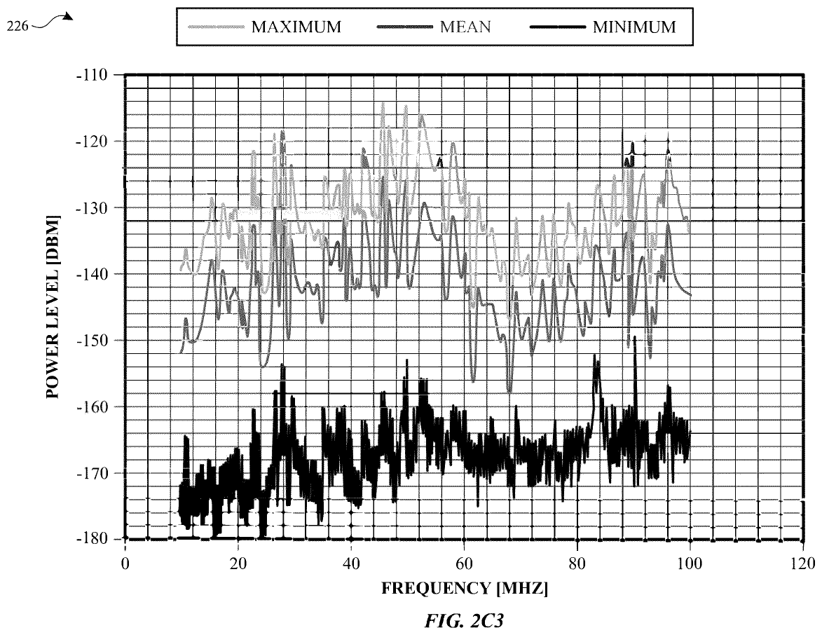

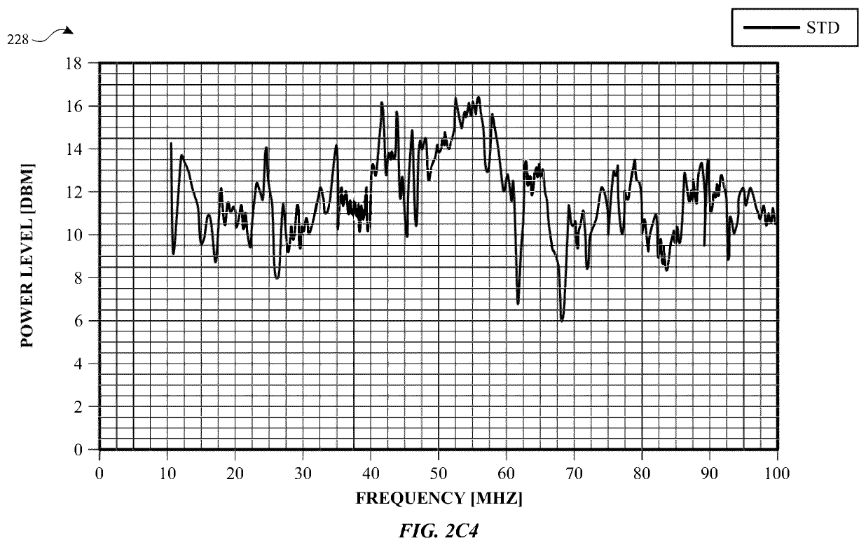

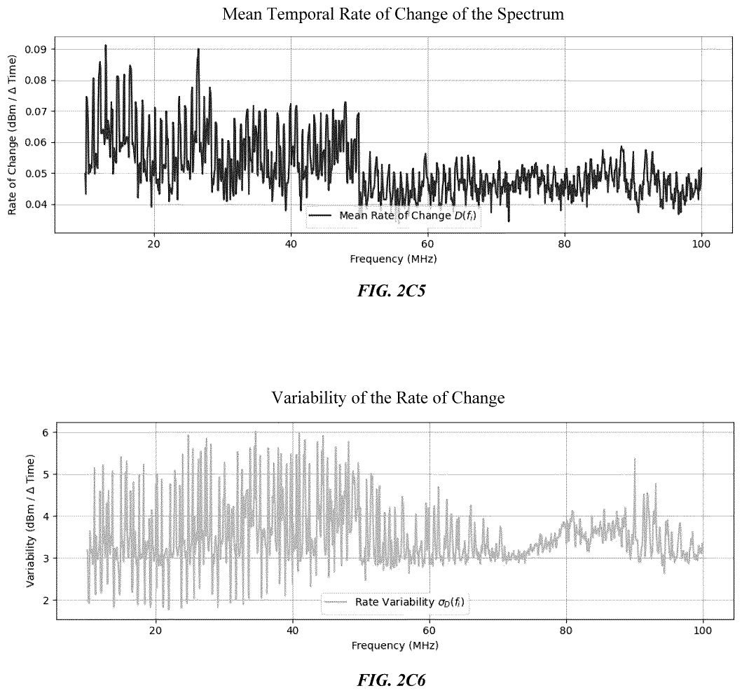

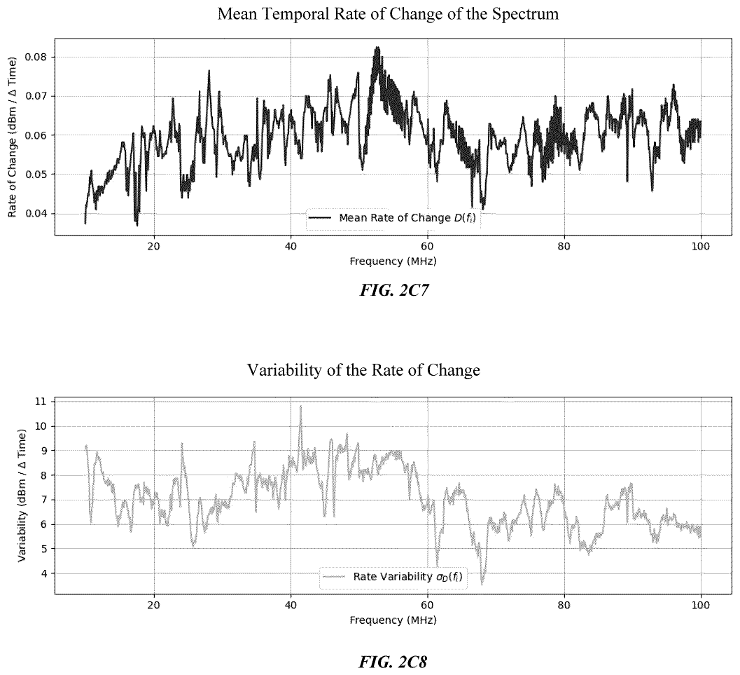

FIG. 2A shows a diagram illustrating a relationship between three components of a noise localization architecture 202. In particular, the noise localization architecture includes a data collection engine 105 configured to collect telemetry data from a data network. As shown in FIG. 1 data collection engine 105 can be located in central office 102 to allow for telemetry collection directly from data network 100. Data collection engine 105 can also be configured to evaluate incoming telemetry data to determine in real-time or at predetermined sampling intervals when one or more channels are being adversely affected by upstream noise. This real-time data can be used in many ways. For example, the real-time data can be used to populate a noise alarm dashboard and generate an alert that is communicated to one or more operators or maintainers of the data network that one or more potential problems are occurring within the data network. In addition to generating an alarm in response to trouble on the data network, data collection engine 105 can be configured to increase a rate that it collects telemetry from the data network and send the telemetry on for further analysis to a data analysis engine 204 with a notification of the one or more detected problems. Data collection engine 105 can also be configured as a gathering point for data received by reported customer issues/complaints. Consequently, data collection engine 105 can be configured with a ticketing system configured to track user reported complaints. In some embodiments, instruction and feedback collection engine 206 can be configured to increase collection of telemetry data generated by a bonding group in which the user's CPE (i.e. modem) belongs and then notify data analysis engine 204 of the problems identified by the user for further analysis. In some embodiments, data collection engine 105 can be configured to update or cancel a trouble ticket generated from customer feedback with information gathered from the telemetry data generated by the data network. However, full analysis of the telemetry data is generally performed at data analysis engine 204 as well as the decision on whether to update or cancel the trouble ticket. Data collection engine 105 could also be configured to group the customer trouble ticket with one or more additional system generated trouble tickets at which point the trouble tickets could be sent directly to an instruction and feedback collection engine 206 or processed first by a data analysis engine 204 before being routed to instruction and feedback collection engine 206. Telemetry data indicating a suspected network point of network degradation is forward to a data analysis engine 204. In some embodiments, the evaluation criteria for identifying telemetry data causing upstream noise can be an upstream channel with noise exceeding a threshold noise level.

Data analysis engine 204 includes criteria for characterizing telemetry data received from data collection engine 105 and noise localization algorithms for identifying suspected sources of the noisy upstream channels. Data analysis engine 204 will generally analyze telemetry data over multiple periods of time in order to identify variations in noise generated on a particular upstream channel. Data analysis engine 204 can also be configured to confirm suspected points of network degradation identified in a trouble ticket received from data collection engine 105 should be investigated by technicians and may also provide additional troubleshooting steps that should be performed when investigating a suspected point of network degradation. As mentioned above, data analysis engine 204 can also be employed to merge and/or combine multiple trouble tickets together when telemetry data received indicates a link between problems being experienced by multiple devices operating on the data network. In some embodiments, an action for combination can be initiated when a threshold number of trouble tickets correlate to a particular suspected point of network degradation. This can greatly improve efficiency by avoiding a situation in which multiple network technicians are dispatched to different user residences in order to solve the same problem. In some embodiments, the noise localization algorithms can be updated or fine-tuned using feedback data gathered while troubleshooting detected noise and impaired network components on the data network.

For example, in the event a customer service representative (CSR) is on the phone with a customer complaining of poor data network service, the customer service representative employing the described embodiments is able to check the subscriber's CPE (cable modem) telemetry data. The CSR is then able to check to see if there is a trouble ticket for the segment of network feeding the subscriber's CPE. If there is no current trouble ticket associated with the network issues, the CSR can initiates analysis of the network segment. As part of the data analysis engine 204 analysis results the CSR receives information about the health of the network and a score for the health of the CPE. With this information the CSR can make an informed decision as how to open a trouble ticket and dispatch technicians to fix the issues.

Data analysis engine 204 is also capable of providing and/or configured to provide updates to a network technician at a customer's place of residence. For example, a troubleshooting checklist may instruct the technician to check a health score for a CPE prior to swapping out the CPE. In the event the health score indicates the CPE does not need to be swapped out the technician can instead of swapping the CPE move directly to initiating a trouble ticket to investigate issues related to a network segment of the data network responsible for servicing the customer.

Data analysis engine 204 can also be configured to intercept and validate a certain subset or in some cases all trouble tickets and send out notifications if it determines that a particular trouble ticket is unnecessary. In the event a trouble ticket is deemed to be unnecessary, data analysis engine 204 can be configured to institute a new trouble ticket addressing what is determined to be a more likely cause of the issues that led to creation of the trouble ticket. Alternatively, in the event a trouble ticket is being canceled because data analysis engine 204 determines that competition of a related trouble ticket should have addressed the issue, additional actions could be limited to sending an automated email to a customer asking the customer to confirm that their issues have been addressed and no further action is needed. This interception and validation process differs from situations in which cable operators experience and report wide spread service outages since noise issues more commonly cause degradation of service rather than loss of service and may affect different users in different ways. For this reason, noise-based outages are typically more difficult to identify and fix than wide spread outages.

The feedback data is first processed by instruction and feedback collection engine 206. In some embodiments, instruction and feedback collection engine 206 acts as an interface between noise localization architecture 202 and network technicians. In its role as the interface, instruction and feedback collection engine 206 is responsible for transmitting reports instructing the network technicians how to troubleshoot and document suspected network impairments and also for receiving the feedback data from the network technicians. In some embodiments, instruction and feedback collection engine 206 will transmit autonomous requests for additional feedback data from network technicians where data has been left blank, feedback data appears to be erroneous or where additional data collection is needed to properly determine which network components caused the network impairments. In some cases, instruction and feedback collection engine 206 may opt to send another technician to investigate a particular network component or a network segment when the actions of the first network technician either failed to fix the impairment or failed to properly document steps taken while troubleshooting the network component.

Instruction and feedback collection engine 206 is also responsible for sending feedback data back to data analysis engine 204 where, as described above, the feedback data can be used to train one or more of the noise localization algorithms. In some embodiments, instruction and feedback collection engine 206 can be responsible for using at least a portion of the feedback data to label the collected telemetry data with identified impaired network components that generated the noise identified by the collected telemetry data. Once labeled the collected telemetry is more easily able to be used as machine learning training data to improve the noise localization algorithms. In some embodiments, data analysis engine 204 is configured to perform some of the labeling of the collected telemetry data. Generally, data analysis engine 204 will be responsible for performing data labeling in more complex noise localization scenarios that might include multiple sources and/or different types of noise.

In addition to the interactions describe above data analysis engine 204 can also be configured to adjust the operation of data collection 105 and instructions and feedback collection engine 206 in response to development of the noise localization algorithms indicating that, e.g., a lower or higher noise localization metrics threshold should be used with data collection engine 105 or where instructions issued to the network technicians by instruction and feedback collection engine 206 be adjusted to perform troubleshooting more quickly or with greater accuracy. Furthermore, and as described herein, noise localization architecture 202 can be further developed by training the architecture using lab generated training data. In this way, noise localization architecture can be developed more quickly and efficiently and be capable of identifying and supplying and/or configured to identify and supply solutions to address problems that may have occurred infrequently or not have previously occurred at all on the operational HFC data network.

In some embodiments, a respective label comprises two portions: (1) a respective set of network conditions for the network and (2) a respective set of location information of modems in the network. Thus, a respective label corresponds to (e.g., includes and/or references) both information about the network conditions and the modem locations at a respective time.

In some embodiments, the respective set of network conditions are based on (e.g., are defined by) one or more impaired network components incorporated into one or more specific locations of the network, causing distortion and noise within the network and/or allowing noise to enter the network from outside the network. In some embodiments, one or more noise sources also emit noise into the environment surrounding the network (e.g., while the one or more impaired network components are part of the network). In some embodiments, the respective set of network conditions includes information about the one or more impaired network components (e.g., the types of the one or more impaired devices, how long the one or more devices have been impaired, the degree of impairment, and/or the location of the one or more impaired network components (e.g., in relation to other network components)).

In some embodiments, the respective set of location information of modems includes information about the topology of the network, the quantity of modems and/or other network components, the make/model of modems, respective distances between/among modems, and/or respective distances between modems and the CTMS.

Thus, a particular label is optionally applied to data that identifies a set of network conditions (e.g., including the quantity, type, and/or location of impaired network components where noise originates in the network and/or including the quantity, type, and/or location of noise sources emitting noise into the environment surrounding the network) and that identifies a set of location information of modems in the network. In some embodiments, the particular label is associated with telemetry data of the network (e.g., DOCSIS timing offsets, receive power, and/or transmit power of different network components).

By automating the introduction of different types of noise (e.g., different noise sources, different noise types, and/or different degrees of noise) into the network and collecting and labeling data corresponding to the respective set of network conditions and the respective set of location information of modems in the network while the different types of noise are introduced into the network, the system can generate data for various types of network conditions and label them appropriately.

In some embodiments, the set of network conditions includes characteristics of the noise (e.g., the noise type) and/or characteristics of the impaired network component (e.g., the impaired network component type). In some embodiments, a number (e.g., 5, 10, 50, 200, or 3,000) of noise sources and/or real-world impaired network components (e.g., impaired network components retrieved from deployed networks) are tested, characterized (e.g., to get characteristics of the noise and/or to get characteristics of the impaired network component), and cataloged for use in a simulated data network for use in labeling. In some embodiments, the set of network conditions includes the characterization of the noise sources and/or impaired network components included in the characterized network. In some embodiments, the set of network conditions includes the make/brands, models, and/or firmware of network components, such as cable modems, CMTSs, fiber nodes, amplifiers, and other passive network components such as splitters, directional couplers, taps. In some embodiments, the set of network conditions includes make/brand/type, length of cables, and/or make/brand/type of connectors. In some embodiments, the set of network conditions includes calibration data (e.g., for DOCSIS parameters) reported by the network components.

Various techniques can be used to determine the characteristics of the impaired network component (e.g., the impaired network component type). In some embodiments, the impaired network component is characterized by a description, such as “loose connector”. However, such a description provides only limited information about the impaired network component. For example, an impaired network component that is a “loose connector” could refer to multiple different conditions, including different types of cable, different types of connectors, and different degrees of looseness of the connection of the cable to the connector. In some embodiments, the impaired network component is characterized a transmission line model, as described in detail below. In some embodiments, the impaired network component is characterized by network telemetry data and/or parameters (e.g., DOCSIS parameters and/or PNM parameters) obtained from the CMTS and/or from cable modems on the network, as described in detail below.

As shown in FIG. 2B1, an exemplary technique for characterizing the impaired network component as a transmission line model, in accordance with some embodiments. In the example of FIG. 2B1, a three-port transmission line model 210 uses S-parameters 210A to characterize the behavior of an impaired network component. In some embodiments, the three-port transmission line model characterizes the impaired network component as a transmission line with particular characteristics. In some embodiments, port 1 and port 2 of the transmission line model is based on (e.g., describes) the signal transmission and the signal reflection, and port 3 of the transmission line model is based on (e.g., describes) signal leakage and ingress. In some embodiments, port 1 of the transmission line model is based on (e.g., describes) the signal transmission, port 2 of the transmission line model is based on (e.g., describes) the signal reflection, and port 3 of the transmission line model is based on (e.g., describes) signal leakage and ingress. In some embodiments, the impaired network component is connected to a network analyzer and the S-parameters (e.g., less than all or all) are measured (e.g., without connecting the impaired network component to a simulated data network). In some embodiments, one or more of the S-parameters are captured over a range of frequencies (e.g., from 1 Mhz, 5 Mhz, or 20 Mhz to 50 MHz, 100 MHz, 200 MHz, 1.2 GHz, or 1.8 GHz). In some embodiments, less than all of the S-parameters are used characterize the impaired network component. In some embodiments, all of the S-parameters are used characterize the impaired network component.

FIG. 2B2 illustrates exemplary S-parameters for a hardline coaxial cable with a broken radial shield, in accordance with some embodiments. Graph 212A illustrates the S₂₁ parameter showing signal transmission at frequencies between 5 MHz and 100 MHz for the hardline coaxial cable with a broken radial shield. Graph 212B illustrates the S₃₁ parameter showing signal leakage at frequencies between 5 MHz and 100 MHz for the hardline coaxial cable with a broken radial shield.

FIG. 2B3 illustrates exemplary S-parameters for a corroded power splitter, in accordance with some embodiments. Graph 214A illustrates the S₂₁ parameter showing signal transmission at frequencies between 5 MHz and 100 MHz for the corroded power splitter. Graph 214B illustrates the S₃₁ parameter showing signal leakage at frequencies between 5 MHz and 100 MHz for the corroded power splitter.

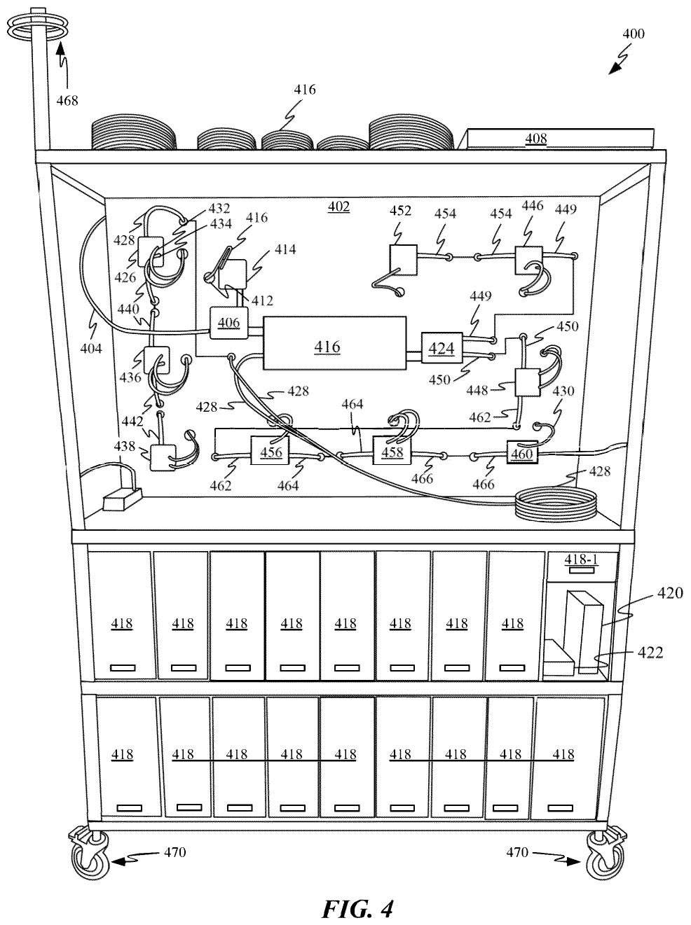

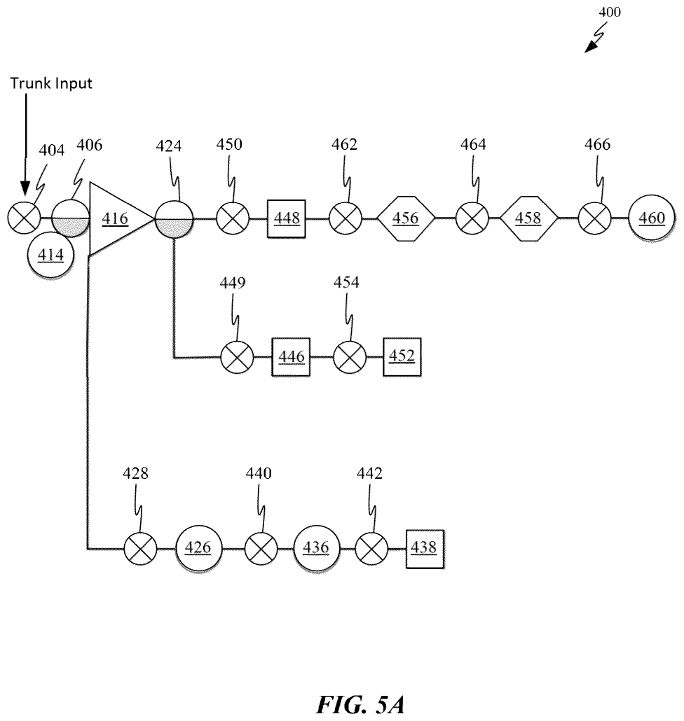

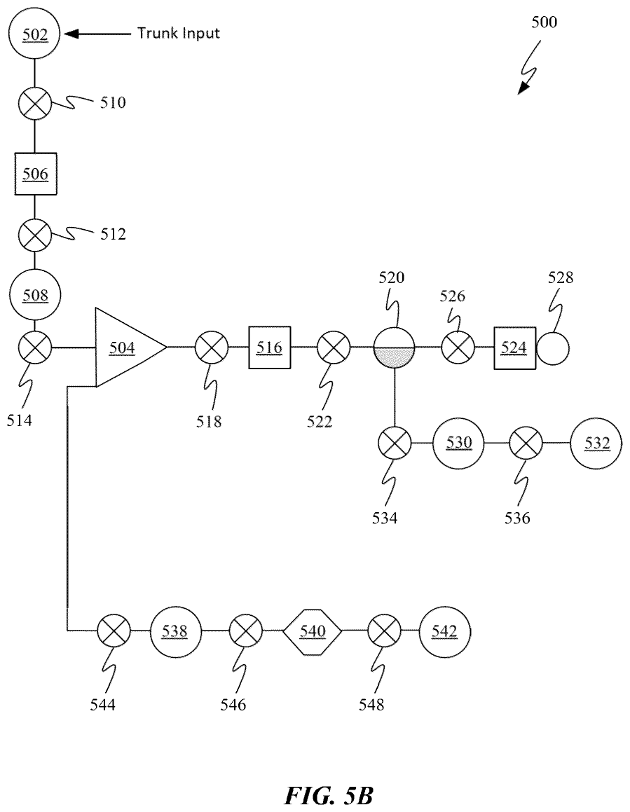

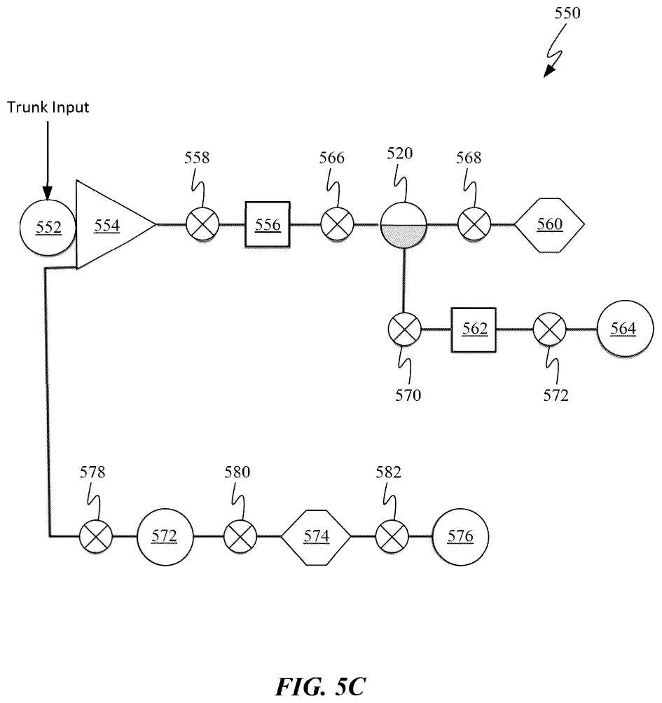

An exemplary technique for characterizing the impaired network component is by obtaining network telemetry data and/or parameters (e.g., DOCSIS parameters and/or PNM parameters) from the CMTS and/or from cable modems on the network. For example, the impaired network component is inserted into the simulated network (e.g., network as shown in FIGS. 4, 5A, 5B, and/or 5C) and network telemetry data and/or parameters are obtained from the CMTS and/or from cable modems on the data network (e.g., without using a separate network analyzer). In some embodiments, the parameters include one or more of: In-Channel Equalizer Frequency Response (ICEFR) (e.g., DOCSIS ICEFR) and Downstream Full Band Spectrum (e.g., for DOCSIS). In some embodiments, the parameters are collected from one, multiple, or all modems on the data network. In some embodiments, multiple modems affected (e.g., all modems affected) by this impaired network component exhibit similar parameters (e.g., similar ICEFR and/or similar downstream Full Band Spectrum).

FIGS. 2B4-1 and 2B4-2 illustrates exemplary In-Channel Equalizer Frequency Response (ICEFR) graphs for two distinct cable modems on the same network that are affected by a loose splice connector on a hardline coaxial cable, in accordance with some embodiments. Graph 216A illustrates the ICEFR for a first cable modem while the loose splice connector on a hardline coaxial cable is part of the data network. Graph 216B illustrates the ICEFR for a second cable modem, different from the first cable modem, while the loose splice connector on the hardline coaxial cable is part of the data network. As shown in FIGS. 2B4-1 and 2B4-2, different cable modems affected by the same impaired component have a similar (or the same) In-Channel Equalizer Frequency Response (ICEFR). Accordingly, the In-Channel Equalizer Frequency Response (ICEFR) can serve as a distinctive signature or characteristic of the impaired network component.

FIGS. 2B5-1 and 2B5-2 illustrate exemplary In-Channel Equalizer Frequency Response (ICEFR) graphs for two distinct cable modems on the same network that are affected by a defective tap, in accordance with some embodiments. Graph 218A illustrates the ICEFR for a third cable modem while the defective tap is part of the data network. Graph 218B illustrates the ICEFR for a fourth cable modem, different from the third cable modem, while the defective tap is part of the data network. As shown in FIGS. 2B5-1 and 2B5-2, different cable modems affected by the same impaired component have a similar (or the same) In-Channel Equalizer Frequency Response (ICEFR). Accordingly, the In-Channel Equalizer Frequency Response (ICEFR) can serve as a distinctive signature and/or characteristic of the impaired network component.

FIGS. 2B6-1 and 2B6-2 illustrate exemplary Full Band Downstream Spectrum graphs for two distinct cable modems on a network that includes a corroded tap, in accordance with some embodiments. Graph 220A illustrates the Full Band Downstream Spectrum from 5 MHz to about 1200 MHz (or 1800 MHz) for a cable modem that is being affected by the corroded tap, thereby causing a suckout at around 575 MHz. Graph 220B illustrates the Full Band Downstream Spectrum from 5 MHz to 1000 MHz for a cable modem that is not being affected by the corroded tap, thereby not causing the suckout at around 575 MHz, even though the defective tap is part of the data network. Cable modems downstream of an impaired network component affecting the downstream spectrum exhibit a similar Full Band Spectrum. Accordingly, the Full Band Spectrum of the affected modem by an impaired network component can be used as a distinctive signature and/or characteristic of the impaired network component.

In some embodiments, the technique characterizes the impaired network component by using one or more (e.g., one, two, or all) of the techniques described above, including a description of the impaired network component, the transmission line model, and parameters (e.g., DOCSIS parameters and/or PNM parameters) obtained from the CMTS and/or from cable modems on the network (e.g., via analysis of the ICEFR and/or the Full Band Downstream Spectrum).

As described above, noise from the environment of the data network may enter the data network, potentially causing undesirable results. Typically, RF noise originates from various sources, such as household appliances, industrial machinery, and lighting. Each source of RF noise exhibits unique noise characteristics that can be identified. These characteristics vary widely, including impulse noise, white noise, and/or noise that is more pronounced at specific frequencies. The nature of the noise can be steady, fluctuating over time, and/or sporadic. Generic labels like “noise from a desk lamp” may be inadequate to characterize the noise because of the significant variations in noise, even among similar noise-causing sources. Accurately characterizing different types of noise ingress can provide significant benefits when analyzing a data network. In some embodiments, one or more parametric models are used to characterize noise. In some embodiments, a noise characterization model uses statistical parameters for different frequency bands of the noise spectrum. Such a noise characterization model is particularly helpful because noise spectrum can dynamically change or remain static over time for different frequency bands of the spectrum. In this model, the noise is characterized based on one or more (e.g., less than all or all) of the following parameters: the maximum spectrum of noise, the minimum spectrum of noise, the mean spectrum of noise, and the standard deviation of noise power at different (e.g., a plurality of) frequencies.

FIG. 2C1 illustrates exemplary maximum, mean and minimum noise spectrums 222 for different frequencies for a first noisy LED light, in accordance with some embodiments. FIG. 2C2 illustrates an exemplary noise spectrum standard deviation 224 for the first noisy LED light, in accordance with some embodiments.

FIG. 2C3 illustrates exemplary maximum, mean and minimum noise spectrums 226 for different frequencies for a second noisy LED light that is different from the first noise LED light, in accordance with some embodiments. FIG. 2C4 illustrates an exemplary noise spectrum standard deviation 228 for the second noisy LED light, in accordance with some embodiments.

In some embodiments, power levels and Modulation Error Ratio (MER) parameters are used for noise and impairment localization, as well as for network topology analysis. These parameters allow for the derivation of Noise Spectral Density (NSD) across different network segments, providing insights into noise origins within the data network. However, the process faces a significant challenge due to the complex, non-linear relationships between NSD, power level, and MER, which vary across different modem brands, models, hardware versions, and firmware. To account for the variance of different modem brands, models, hardware version, and/or firmware version, various devices are tested using a measurement setup and a calibration table is generated that corresponds different modem brands, models, hardware versions, and/or firmware versions to their respective the MER and power levels.

Using the characteristics described above, multiple labels are generated, with a first label corresponding to a first set of network conditions for the network and a first set of location information of modems in the network and a second label corresponding to a second set of network conditions for the network and a second set of location information of modems in the network. In some embodiments, numerous labels are generated, each corresponding to a respective set of network conditions for the network and a respective set of location information of modems in the network. The label and corresponding information are used to train one or more machine learning models for predicting and identifying one or more of: location(s) where noise is entering the data network, types of noise entering the data network, location(s) where nonlinear distortion is originated in a data network, types of nonlinear distortion such as CPD or amplifier saturation, location(s) of failed or impaired network components, type(s) of failed and/or impaired network components, impact of impaired network component(s) on the noise and distortion, cable modem health versus performance, and network topology.

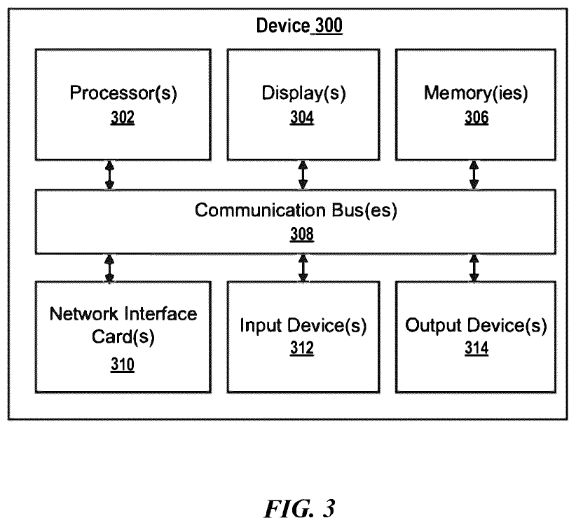

FIG. 3 illustrates an exemplary electronic device (e.g., a server, a computer, and/or a network component), in accordance with some embodiments. In some examples, the techniques described herein can be performed at device 300. Device 300 is an electronic device with one or more processors 302, one or more displays 304, one or more memories 306, one or more network interface cards 310, one or more input devices (e.g., keyboard 312), one or more output device 314 (e.g., printer), connected via one or more communication buses 308. Many of elements of device 300 are optional, such as display 304, input devices 312, and output devices 314. Memories 306 can include random access memory, read-only memory, flash memory, and the like. Memory 306 can include a non-transitory computer-readable storage medium. The non-transitory computer-readable storage medium is configured to store one or more programs configured to be executed by the one or more processors 302 of device 300. The one or more programs optionally include instructions for performing the described techniques.

FIG. 4 shows an exemplary movable rack 400 capable of organizing and shielding and/or configured to organize and shield various network components capable of simulating and/or configured to simulate an HFC data network for test operation within a controlled lab environment. In particular, movable rack 400 includes a rear panel 402 with network components for modeling a trunk of the HFC data network mounted thereto. In some embodiments, rear panel 402 can be made of an electrically insulating material such as plywood. As depicted, test network traffic from a fiber node or another branch of the HFC network (i.e. a fiber node within a lab environment or another movable rack within the lab environment) is received from coaxial cable 404 at directional coupler 406. A traffic generator 408 is illustrated atop movable rack 400 and provides exemplary network traffic signals that can be broadcast upstream by CPE devices disposed within shielded enclosures 418. The exemplary network traffic generated by traffic generator 408 helps to establish an ordinary volume of network traffic on the network branch supported by movable rack 400. In some embodiments, the exemplary network traffic can be network traffic recorded from an operational data network to help with realism of the network traffic.

Directional coupler 406 is configured to route the test network traffic to network tap 414 and trunk amplifier 416. Network tap 414 includes a coaxial cable 416 that acts as a drop cable for connecting network tap 414 to a CPE device located in one of shielded enclosures 418. Coaxial cable 416 can have a length corresponding to its actual length in an operational HFC data network by coiling and optionally placing a central portion of coaxial cable 416 atop movable rack 400 as depicted. Using coaxial cable 416 (and, optionally, other coaxial cables described herein) that is rolled up enables simulating various distances based on the length of coaxial cable 416. While shielded enclosures 418 can take many forms, shielded enclosures act effectively as faraday cages to prevent CPE devices or other network components disposed within them from being adversely affected by operation of other network components supported by movable rack 400 or other sources of electromagnetic interference (EMI) within the lab environment. Shielded enclosures 418 can also include shielded ports that prevent any cables routed into a respective shielded enclosure 418 from introducing EMI into the respective shielded enclosure 418. Shielded enclosure 418 is shown in an open state to illustrate how a CPE device 420 and optionally a drop amplifier 422 can be positioned within shielded enclosure 418-1. Drop amplifiers 422 are typically needed when a particularly long drop cable is used and/or when the signal strength at the network tap is too low to reach a particular CPE device.

Trunk amplifier 416 is configured to output the received test and exemplary network traffic to directional coupler 424 and to network tap 426, which ultimately lead to three different branches. The traffic is sent to network tap 426 via a coaxial cable 428, a central portion of which is coiled on a shelf that is optionally positioned directly beneath rear panel 402. Network tap 426 in turn is connected to two coaxial cables 432 and 434, which connect network tap 426 to two CPE devices located within respective shielded enclosures 418 to the network components mounted on rear panel 402. Network tap 426 is also in electrical communication with network taps 436 and 438 via coaxial cables 440 and 442. In a similar manner, network taps 436 and 438 can each be connected to two CPE devices disposed within shielded enclosures 418.

Directional coupler 424 sends the traffic receive from trunk amplifier 416 to network tap 448 and network tap 446 via respective coaxial cables 449 and 450. Coaxial cables 449 and 450 are also shown extending through openings in rear panel 402 and also can be of a length typically used in an operational HFC data network. While coils of central portions of coaxial cables 449 and 450 are not depicted, in some embodiments, these coiled cables can be hung from pegs on a rear-facing surface of rear panel 402. As described in the preceding paragraph, network tap 446 is in electrical communication with network tap 452 via coaxial cable 454 and network tap 448 is in electrical communication with network taps 456, 458 and 460 via coaxial cables 462, 464 and 466. In some embodiments, the components of movable rack 400 are connected to the input of another movable rack such as movable rack 400, 500, and/or 550. In some embodiments, 2, 3, 4 or 5 racks are connected via respective connections.

Other features of movable rack 400 include antenna 468, which can be configured to operate in a few different ways. When the lab environment is not shielded from ambient RF signals, antenna 468 can be configured to measure ambient FM radio waves so that the effect of the ambient FM radio waves on any of the network components carried by movable rack 400 can be removed to improve the quality of any telemetry data gathered. Alternatively, antenna 468 can be configured to create ambient noise within the lab environment to help more closely approximate conditions in an operational HFC data network by transmitting FM or LTE radio waves. In some embodiments, movable rack 400 can include multiple antennas configured to receive or broadcast FM, LTE or other cellular signals to further model and/or collect normal ambient conditions for an HFC data network. Movable rack 400 is also depicted including wheels 470, which allow for movable rack 400 to be repositioned within the lab environment. In some embodiments, the lab environment can include shielding enclosures large enough to allow movable rack 400 to be placed within so that movable rack 400 can be isolated from RF interference generated by network components supported by other movable racks supporting other parts of an HFC network or any other possible unintentional sources of noise present in the lab environment.

Testing personnel can introduce noise into the network components supported by movable rack 400 in the lab in a variety of ways. One way of making sure that a consistent coupling between the impairment source and the affected network component is to use an antenna to capture noise from a noise source. The antenna may be different for different types of noise and the source that emits the noise. Some examples of antenna (but not limited to) are the following: a coil of wire wrapped around the source of noise, for example a noisy power adapter, a short wave radio dipole antenna; a short wave radio coil antenna; and an FM antenna. The noise captured by the antenna can then be transmitted to the affected network component or components to create a desired impairment condition in at least the following ways: antenna wire directly connected to the shielding of a coaxial cable going to the network component(s); antenna wire placed in parallel with a coaxial cable going to the network component(s); antenna wire connected to another antenna to transmit the noise in the air, which then will be received by the network component(s); and antenna wire connected to another antenna to transmit the noise inside a reflective enclosure with the network component(s) inside it, which then will be received by the impairment.

One type of condition the laboratory environment is particularly good at monitoring is a time varying impairment, which is quite difficult to monitor in an operational environment due to the condition often not being caught or identified at an early stage. It is important to have training data representative of each stage of a time varying impairment in order for an AI driven system to be able to spot and identify time varying impairments at its different stages. For example, a network component exposed to water develops corrosion over a period of time and its electrical characteristics change in time. When a wet corroded network component becomes dry over a certain period of time its electrical characteristics changes. Other environmental factors can affect the impairment over time, for example, the effect of temperatures on a wet cable when it goes below freezing point can be significant. Wind can have a notable effect on a loose amplifier connector. The time varying impairments also must be simulated and properly labeled at their various severities to allow machine learning algorithms to properly identify these types of impairments regardless of what stage or severity a particular impairment is in. This allows identification of the issue at an early stage and for an HFC data network operator to be able to schedule a maintenance action to occur before the impaired component is projected to cause an impairment having a substantial effect on the customers relying on the HFC data network.

Impairment in network components generally fall in the following categories: (1) physical damage; (2) water damage; (3) fiber node misalignment; (4) amplifier misalignment; and (5) in-home impairments. Physical damage impairments include physical damage to the cable and connector (e.g., loose connectors and adapters, cable radial shield cracked, center connector dirty, center connector too long, damaged cable—crushed, damaged cable—sharply bent, damaged cable—hole in the shield), physical damage to the fiber node (e.g., damaged FN cover, damaged or missing seal), physical damage to the amplifier (e.g., damaged amplifier cover, damaged or missing seal), physical damage to the directional coupler/splitter (e.g., damaged cover, damaged or missing seal), physical damage to the power injector (e.g. damaged cover or damaged or missing seal), physical damage to network taps (e.g., damaged covers or damaged or missing seals).

Water damage impairments include water damage to the cable and connector, water damage to the fiber node, water damage to the amplifier, water damage to the directional coupler/splitter, water damage to the power injector and water damage to the network taps. Water damage to these network components generally takes the form of water within the network component, corrosion within the network component and wet or dry corrosion on any of the seals of the network component.

Fiber node misalignment typically takes the form of fiber node input amplifier overload, fiber node input amplifier underload or fiber node laser clipping. Amplifier misalignment is generally shown by amplifier overload or underload. Fiber node misalignment and amplifier misalignment generally cause signal degradation. This degradation can be similar to the effect on the network caused by other sources of noise as they all tend to cause reduction in signal quality and increases in bit error rate. Consequently, having training data capable of accurately characterizing the noise generated by fiber or amplifier misalignments helps distinguish misalignment conditions from other types of noise present in an HFC data network.

In-home impairments typically are caused by problems with the drop cable, various in-home network components and various interference generated within a customer's premises and various defects of the customer's CPE device.

Each of the aforementioned impairment types would generally be characterized with telemetry data labeled in accordance with the type of impairment being simulated, the location of the impairment (impaired network components) and the type of noise generated. Sometimes, a simulation can include multiple types of impairments causing multiple types of noise being originated from different locations. For example, a primary impairment substantially responsible for causing an outage or degradation in service could be masked or obscured in part by other less serious impairment types. By simulating multiple impairments concurrently in this way and using the resulting training data to train an AI based impairment identification system, such as the one described in FIG. 2, these unusual impairments can be quickly understood by the AI based impairment identification system and properly addressed quickly without having to do time-consuming investigation.

FIGS. 5A-5C show schematic illustrations of three exemplary movable rack configurations. FIG. 5A is a schematic illustration of movable rack 400 shown in FIG. 4. The description of the schematic illustration of movable rack 400 will be brief since the routing of signals has already been described in the text accompanying FIG. 4. It should be noted that CPE devices are not depicted in FIG. 5A so that focus can remain on the network components forming this trunk of the HFC data network and that each depicted network tap is connected by drop cable and sometimes a drop amplifier to at least one CPE device. The network taps can also be connected to one or more set top boxes for streaming digital television. It should also be noted that the network taps have different shapes that indicate different types of network taps. In particular, hexagonally-shaped network taps indicate the network tap has eight terminals for drop cables, square-shaped network taps indicate the network tap has four terminals for drop cables and circular-shaped network taps indicate the network tap has two terminals for drop cables. The length of coaxial cables running between network components can optionally be varied to more accurately model a particular HFC data network. The coaxial cables for the HFC data network trunk depicted in FIG. 5A are typically outdoor rated cables of type RG-6 and have the following lengths: coaxial cable 404 is 50 ft, coaxial cable 428 is 200 ft, coaxial cable 440 is 200 ft, coaxial cable 442 is 200 ft, coaxial cable 450 is 200 ft, coaxial cable 462 is 200 ft, coaxial cable 464 is 50 ft, coaxial cable 466 is 50 ft, coaxial cable 449 is 200 ft and coaxial cable 454 is 100 ft.

FIG. 5B shows a schematic view of movable rack 500. Trunk input signals are configured to enter network components of movable rack 500 through network tap 502 and progress to trunk amplifier 504 through network taps 506 and 508 and coaxial cables 510, 512 and 514. In some embodiments, coaxial cables 510, 512 and 514 can each have a length of about 100 ft. Trunk amplifier 504 is configured to boost the strength of the trunk input so that the signal is able to propagate through the cabling and network taps associated with the two outputs of trunk amplifier 504. A first output of trunk amplifier 504 goes to network tap 516 by way of coaxial cable 518, which can have a length of 200 ft. Signals exiting network tap 516 then travel to directional coupler 520 by way of coaxial cable 522. Directional coupler 520 routes network traffic to two different branches. A first branch off directional coupler 520 includes network tap 524, which receives a signal from directional coupler 520 by way of coaxial cable 526. Network tap 524 is coupled to power injector 528 without an intervening coaxial cable run. Power injector 528 can be added at the end of this branch to allow for the end of this branch to be connected to the input of another movable rack such as movable rack 400, 500 and/or 550. In some embodiments, 2, 3, 4 or 5 racks are connected via respective power injectors (e.g., power injector 528). A second branch off directional coupler 520 includes network taps 530 and 532, which are in communication with directional coupler 520 by way of coaxial cables 534 and 536. A second output of trunk amplifier 504 goes to network taps 538, 540 and 542 by way of coaxial cables 544, 546 and 548.

FIG. 5C shows a schematic view of movable rack 550. Trunk input signals enter network components of movable rack 550 through network tap 552, which outputs to trunk amplifier 554 without running through a coaxial cable. This models a configuration in which network tap 552 is co-located with trunk amplifier 554. Trunk amplifier 554 has two outputs. A first one of the outputs runs to network tap 556 through coaxial cable 558 and subsequently to network taps 560, 562 and 564, via directional coupler 520 and coaxial cables 566, 568, 570 and 572. A second one of the outputs of trunk amplifier 554 runs to network taps 572, 574 and 576 via coaxial cables 578, 580 and 582. As has been shown, each of the movable racks 400, 500 and 550 have different configurations that allows the movable racks to model different trunks and branches of an exemplary HFC data network.

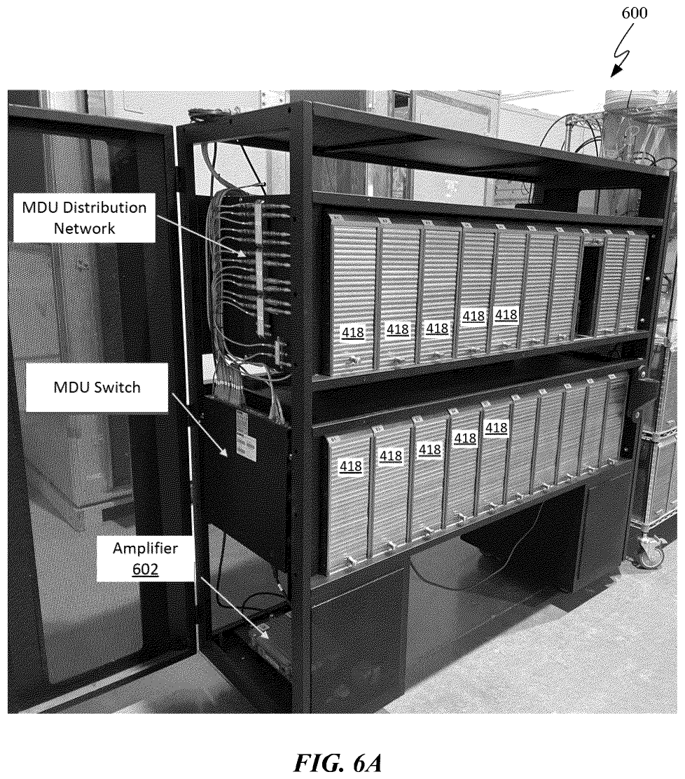

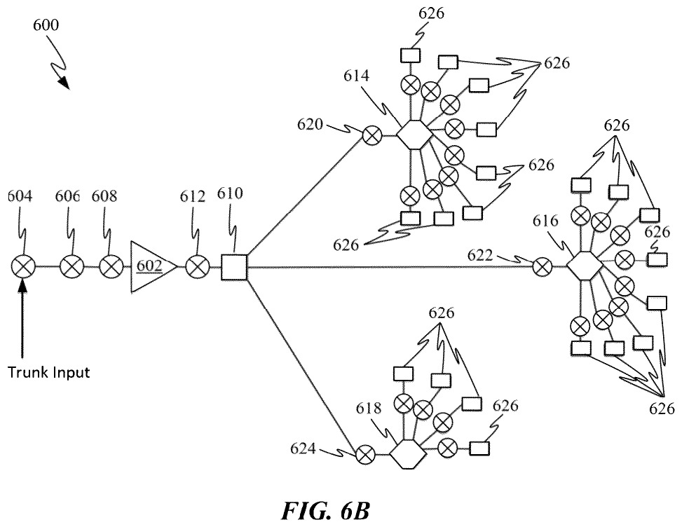

FIGS. 6A-6B show photographic and schematic views of a multi-dwelling unit (MDU) rack 600 that is configured to model impairments that can occur inside one or more buildings, such as an apartment building or cluster of condos. These configurations tend to have different configurations due to the close proximity of dwelling units in these types of housing units. In particular, FIG. 6A shows how MDU rack 600 includes an MDU amplifier 602, an MDU distribution network comprised of a series of splitters and an MDU switch configured to route signals as needed to the various CPE devices disposed within shielded enclosures 418. The MDU switch is used to introduce signals from a traffic generator similar to traffic generator 408 described in conjunction with FIG. 4.

FIG. 6B shows a schematic view of MDU rack 600. In particular, MDU rack 600 includes a series of connected co-axial cables 604, 606 and 608 to model the routing needed to get to the electronics room associated with a particular apartment building or complex of condominiums. MDU amplifier 602 has a single output to network tap 610 via coaxial cable 612. Network tap 610 outputs to three different network taps 614, 616 and 618 via patch cables 620, 622 and 624. In some embodiments, patch cables can have a length of between three and five feet. Network taps 614, 616 and 618 can each include eight terminals for connecting to large numbers of CPE devices 626 located in close proximity.

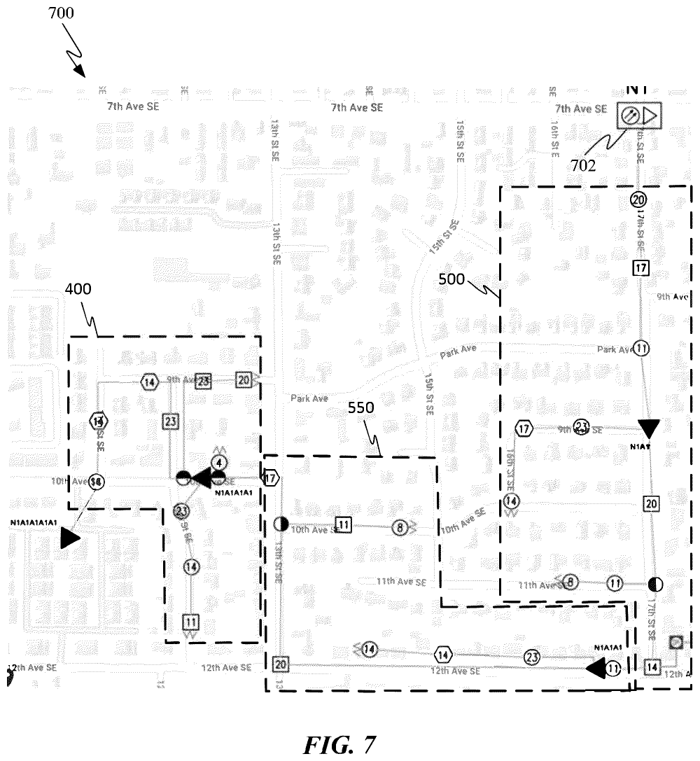

FIG. 7 shows how the network components supported by movable racks 400, 500 and 550 cooperatively simulate an HFC data network 700. In particular, HFC data network 700 includes a fiber node 702 that feeds into a first region of HFC data network 700 simulated by the network components carried by movable rack 500. A second region of HFC data network is simulated by the network components of movable cart 550 and a third region of HFC data network 700 can be simulated by the network components of movable rack 400 as depicted in FIG. 7 by the dashed region that highlight the network components simulated by each movable cart. FIG. 7 also illustrates how the various network components of a respective movable cart are ordinarily distributed across multiple city blocks.

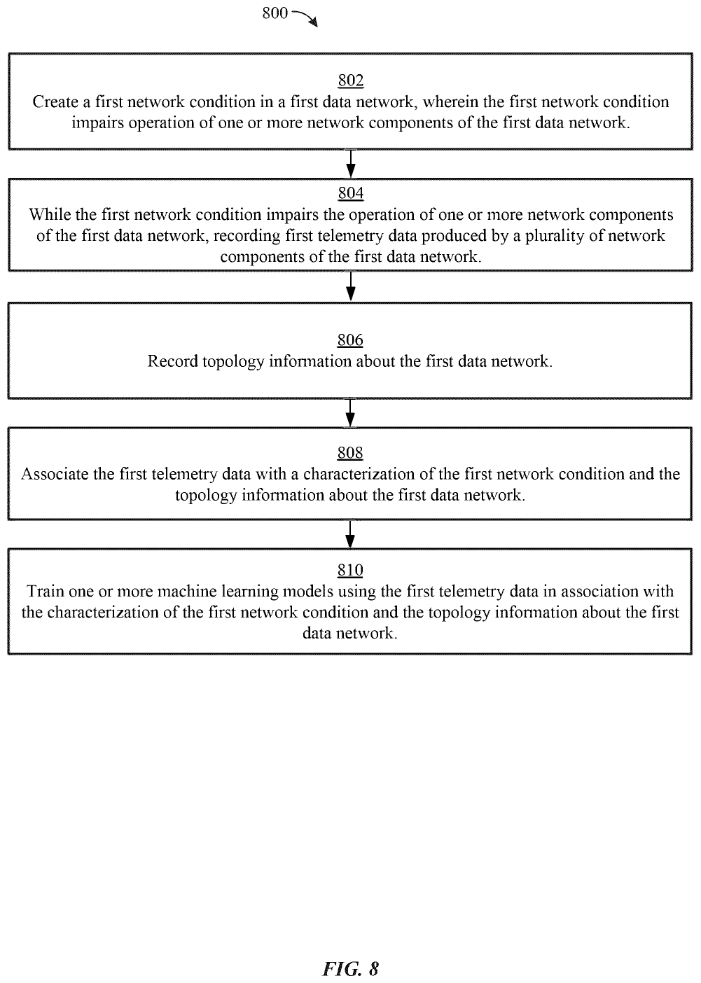

FIG. 8 is a flow diagram illustrating method 800 for analyzing a data network, such as by using a computer system, in accordance with some embodiments. Method 800 is optionally fully or partially performed at a computer system (e.g., with one or more processors and memory storing instructions for performing the method). Some operations in method 800 are, optionally, combined, the orders of some operations are, optionally, changed, and some operations are, optionally, omitted.

As described below, method 800 provides robust technique for analyzing a data network. The method reduces the cognitive burden on a user for managing and analyzing data networks.

The technique includes creating (802) a first network condition (e.g., adding an impaired network component and/or introducing noise) in a first data network (e.g., a simulated data network and/or a data network formed in a lab environment for testing purposes), wherein the first network condition impairs operation of one or more network components (e.g., a cable modem, a splitter, and/or a coax cable) of the first data network.

While the first network condition impairs the operation of one or more network components of the first data network, the technique records (804) first telemetry data produced by a plurality of network components (e.g., one or more network components that have impaired operation due to the first network condition and/or one or more network components that do not have impaired operation due to the first network condition) of the first data network. The technique includes recording (806) (e.g., before, after, and/or while the first network condition is part of the first data network) topology information about the first data network.

The technique includes associating (808) the first telemetry data with a characterization of the first network condition and the topology information about the first data network (e.g., without associating the first telemetry data with a characterization of a second network condition that is different from the first network condition and/or topology information about a second data network that is different from the first data network) and training (810) one or more machine learning models using the first telemetry data in association with the characterization of the first network condition and the topology information about the first data network.

In some embodiments, creating the first network condition in the first data network comprises including a first impaired network component. In some embodiments, examples of an impaired network component include network components with physical damage, with water damage, that have fiber node misalignment, that have amplifier misalignment; and/or are in-home impaired network components. In some embodiments, creating the first network condition in the first data network comprises submersing at least a portion of a respective network component in water.

In some embodiments, the technique includes characterizing the first impaired network component using a transmission line model to determine a characterization of the first impaired network component, wherein the characterization of the first network condition is based on (e.g., uses and/or is the same as) the characterization of the first impaired network component. In some embodiments, a respective impaired network component is characterized while the respective impaired network component is not part of the first data network.

In some embodiments, creating the first network condition in the first data network comprises introducing first noise (e.g., generated by a noise source) into the first data network. In some embodiments, examples of noise sources that introduce noise into a data network include: household appliances, LED lights in the environment of the data network, and RF transmitters in the environment of the data network.

In some embodiments, the technique includes characterizing the first noise using statistical parameters for different frequency bands of the first noise (e.g., the maximum spectrum of noise, the minimum spectrum of noise, the mean spectrum of noise, and/or the standard deviation of noise power at different (e.g., a plurality of) frequencies) to determine a characterization of the first noise, wherein the characterization of the first network condition is based on (e.g., uses and/or is the same as) the characterization of the first noise. In some embodiments, a respective noise and/or noise source is characterized independent of the first data network.

In some embodiments, recording topology information about the first data network comprises recording a make, a model, and/or a version (e.g., a software version and/or a firmware version) of (e.g., of all or less than all) network components (e.g., one or more network components that have impaired operation due to the first network condition and/or one or more network components that do not have impaired operation due to the first network condition) of the first data network.

In some embodiments, recording topology information about the first data network comprises recording locations (e.g., relative to other network components and/or absolute locations) of (e.g., of all or less than all) network components (e.g., one or more network components that have impaired operation due to the first network condition and/or one or more network components that do not have impaired operation due to the first network condition) of the first data network. In some embodiments, recording topology information about the first data network comprises recording information about how network components of the first data network are interconnected.

In some embodiments, recording topology information about the first data network comprises recording cable distances (e.g., in meters and/or in miles) between network components (e.g., one or more network components that have impaired operation due to the first network condition and/or one or more network components that do not have impaired operation due to the first network condition) of the first data network. In some embodiments, recording topology information about the first data network comprises recording information about how network components of the first data network are interconnected.

In some embodiments, the first data network is contained in a laboratory environment. In some embodiments, the first data network is a simulated data network (e.g., a data network with physical components and connections, but that is not a deployed network). In some embodiments, impaired network component is disposed within a first shielded enclosure that isolates the impaired network component from a plurality of network components of the first data network and another network component is disposed within a second shielded enclosure that isolates the another network component from the plurality of network components of the first data network. In some embodiments, the shielded enclosures are faraday cages.

In some embodiments, the technique includes: creating a second network condition (e.g., adding an impaired network component and/or introducing noise), different from the first network condition, in the first data network (e.g., a simulated data network and/or a data network formed in a lab environment for testing purposes), wherein the second network condition impairs operation of one or more network components (e.g., a cable modem, a splitter, and/or a coax cable) of the first data network; while the second network condition impairs the operation of one or more network components of the first data network, recording second telemetry data produced by a plurality of network components (e.g., one or more network components that have impaired operation due to the second network condition and/or one or more network components that do not have impaired operation due to the second network condition) of the first data network; associating the second telemetry data with a characterization of the second network condition and the topology information about the first data network (e.g., without associating the second telemetry data with a characterization of the first network condition and/or topology information about a second data network that is different from the first data network); and training the one or more machine learning models using the second telemetry data in association with the characterization of the second network condition and the topology information about the first data network.

In some embodiments, the technique includes: creating a third network condition (e.g., the same as or different from the first network condition and/or the second network condition) (e.g., adding an impaired network component and/or introducing noise) in a second data network (e.g., a simulated data network and/or a data network formed in a lab environment for testing purposes), different from the first data network, wherein the third network condition impairs operation of one or more network components (e.g., a cable modem, a splitter, and/or a coax cable) of the second data network; while the third network condition impairs the operation of one or more network components of the second data network, recording third telemetry data produced by a plurality of network components (e.g., one or more network components that have impaired operation due to the third network condition and/or one or more network components that do not have impaired operation due to the third network condition) of the second data network; recording (e.g., before, after, and/or while the third network condition is part of the second data network) topology information about the second data network; associating the third telemetry data with a characterization of the third network condition and the topology information about the second data network (e.g., without associating the third telemetry data with a characterization of a first/second network condition and/or topology information about the first data network); and training the one or more machine learning models using the third telemetry data in association with the characterization of the third network condition and the topology information about the second data network.

In some embodiments, the technique includes: recording telemetry data produced by a plurality of network components of a deployed data network (e.g., that is operating with active users) (e.g., different from the first and second data networks); recording topology information about the deployed data network (e.g., wherein the topology information is generated based on the telemetry data and/or based on records of the data network); associating the telemetry data produced by the plurality of network components of the deployed data network with the topology information about the deployed data network; and using one or more machine learning models (e.g., that were training using the first telemetry data, the second telemetry data, and/or the third telemetry data) to determine one or more characteristics of a network condition (e.g., an impaired network component and/or noise) in the deployed data network. In some embodiments, the one or more characteristics includes a location of noise entering the deployed data network and/or a location of an impaired network component in the deployed data network. In some embodiments, the one or more characteristics includes a type, make, model, and/or version of an impaired network component in the deployed data network. In some embodiments, the one or more characteristics includes a type of noise entering the deployed data network.

In some embodiments, a computer system receives first telemetry data produced by a plurality of network components of a first data network that includes a first network condition that impairs operation of one or more network components of the first data network, wherein the first telemetry data was produced while the first network condition impairs the operation of one or more network components of the first data network. The computer system receives and/or determines topology information about the first data network, wherein the topology information about the first data network is associated with a characterization of the first network condition and the topology information about the first data network. The computer system uses the first telemetry data in association with the characterization of the first network condition and the topology information about the first data network to train one or more machine learning models. In some embodiments, the computer system trains the one or more machine learning models on a plurality of respective telemetry data (e.g., second, third, and/or fourth) in association with respective characterizations of respective network conditions (e.g., second, third, and or fourth) and topology information (e.g., second, third, and or fourth) about the respective data networks. In some embodiments, these techniques are implemented by instructions of one or more computer programs stored on one or more computer-readable storage media. In some embodiments, these techniques are implemented by a computer system that includes one or more processors and memory that stores instructions for performing the techniques.

In some embodiments, a method is performed at a computer system. The method comprises: receiving first telemetry data produced by a plurality of network components of a first data network that includes a first network condition that impairs operation of one or more network components of the first data network, wherein the first telemetry data was produced while the first network condition impairs the operation of one or more network components of the first data network; receiving topology information about the first data network, wherein the topology information about the first data network is associated with a characterization of the first network condition and the first telemetry data; and training one or more machine learning models using the first telemetry data in association with the characterization of the first network condition and the topology information about the first data network. In some embodiments, the method performed at the computer system further comprises: receiving second telemetry data produced by a plurality of network components of a second data network, different from the first data network, that includes a second network condition, different from the first network condition, that impairs operation of one or more network components of the second data network, wherein the second telemetry data was produced while the second network condition impairs the operation of one or more network components of the second data network; receiving topology information about the second data network, wherein the topology information about the second data network is associated with a characterization of the second network condition and the second telemetry data; and training the one or more machine learning models using the second telemetry data in association with the characterization of the second network condition and the topology information about the second data network. In some embodiments, the method performed at the computer system further comprises: receiving telemetry data produced by a plurality of network components of a deployed data network that is different from the first data network and the second data network; receiving topology information about the deployed data network; associating the telemetry data produced by the plurality of network components of the deployed data network with the topology information about the deployed data network; and using the one or more machine learning models that have been trained using the first telemetry data and the second telemetry data to determine one or more characteristics of a network condition in the deployed data network, wherein the one or more characteristics of the network condition in the deployed data network includes a location of the network condition in the deployed data network and/or a type of the network condition. In some embodiments, these techniques are implemented by instructions of one or more computer programs stored on one or more computer-readable storage media. In some embodiments, these techniques are implemented by a computer system that includes one or more processors and memory that stores instructions for performing the techniques.

To detect faults and failures in a network, such as a broadband network, it is helpful to understand the network's behavior and performance under specific impairments and the failure modes of various network components. Similarly, to determine the distances between network components and to predict or extract the network topology, it is helpful to analyze the effects of network impairments on time-related parameters. Typically, this requires setting up an experimental environment to simulate the network under targeted conditions, focusing on the faults, failures, and topology being researched. However, configuring such an experimental setup is time-consuming, costly, and lacks scalability, as a single lab setup is usually limited to one experiment.

As described in further detail below, some embodiments include and/or use a general-purpose lab setup that is continuously and/or repeatedly reconfigured, changing network parameters and introducing various impairments across different network components and locations. A large amount of data is collected and stored in a database, covering a wide range of network conditions and failure scenarios. This creates a comprehensive dataset that can be used as pre-conducted experiments.

A front-end application allows users to virtually select a network configuration, introduce impairments, simulate desired network conditions, and run experiments. Since the experiments have already been conducted and the data is readily available, the process is extremely fast. Moreover, the dataset can be replicated or accessed by multiple front-end applications, enabling the lab's digital twins to be used for multiple experiments and by multiple users, thereby solving the issue of scalability.

This technique differs from some other techniques in one or more of the following ways: one of the objectives of the pre-conducted experiments lab with digital twins is to support research in broadband network operation and maintenance; the data collected in the pre-conducted experiments lab with digital twins is comprehensive, including many, most, or all available parameters from the network, its components, and performance monitoring tools; and the pre-conducted experiments lab with digital twins uses a front-end application to configure virtual experimental setups and visualize experiment results in various report formats.

In broadband networks such as HFC, GPON, EPON, and XGS-PON, service providers face significant challenges in network operation and maintenance. Hard failures can cause service disruptions, while soft failures lead to service degradation. Although the types of faults and failures may vary across networks, the general approaches to detect, identify, and localize them are similar. Effective detection and localization of faults rely on understanding how these issues affect both network performance and the telemetry data collected from network components.

To gain this understanding, an experimental setup that simulates a real-world network is helpful. However, due to the vast number of potential faults, failures, and influencing factors—such as environmental noise, temperature, and network traffic—a wide range of targeted experiments is required. Conducting these experiments individually is time-consuming and costly, as an experimental setup can typically only be used for one targeted experiment at a time, limiting scalability.

This technique aims to address these challenges by creating a broadband network setup that mirrors real-world conditions, with various network components and customer premise equipment (CPE). A comprehensive dataset is collected from the network equipment, CPEs, and performance monitoring systems over time. The initial dataset serves as a baseline, with no faults or impairments. Subsequently, various impairments, faults, and failures are introduced at different points in the network, and additional datasets are collected. This process is repeated under different conditions—such as varying temperatures, traffic loads, and power levels—and using different CPE types and network components.

While the comprehensive data collection process is time-consuming, it provides the advantage of creating a large dataset that can be used not only for the targeted experiments at hand but also for future experiments that may arise. These datasets and test results can be considered as pre-conducted experiments, available for future use. Additionally, the technique allows multiple users to access these datasets simultaneously, solving the scalability issue and eliminating the need for duplicating experimental setups—significantly reducing research costs.

In some embodiments, the technique comprises three main components: (a) Lab experimental setup and comprehensive data collection application and/or interface, (b) lab digital twin front-end application and/or interface, and (c) Application Programming Interface (API).

In regard to the lab experimental setup and comprehensive data collection application and/or interface, a versatile network setup is created to mirror real-world broadband networks, allowing comprehensive data collection under various conditions. This includes data from different network components, customer premise equipment (CPE), and varying environmental and operational factors.

In regard to the lab digital twin front-end application and/or interface, a user interface that enables experimenters to: configure and run specific experiments; select impaired components from a catalog and introduce them at specific locations in the network; choose different network environmental or operational conditions (e.g., temperature, traffic load); and/or visualize experiment results in various formats, providing detailed insights into network performance and fault detection.

In regard to the Application Programming Interface (API), a set of APIs that allows the export of the collected data to external applications. For example, this data can be used to train machine learning models for various applications, enhancing its utility beyond experimental setups.

In some embodiments, the data network is a Hybrid Fiber Coax (HFC) networks. In this example, the datasets are collected from a real HFC (Hybrid Fiber Coaxial) network constructed in a controlled lab environment. Multiple real-world impaired or defective network components—such as a loose RF connector, a hardline coaxial cable with a broken radial shield, and a corroded passive component with a degraded RF seal—were characterized and inserted at various locations within the HFC network. These components introduced a range of impairments, including noise ingress, nonlinear distortions, signal level and quality degradation, frequency response distortions, group delays, and more. The result is a comprehensive dataset collected in conjunction with well-characterized and precisely placed impaired components and corresponding impairments in the network.

Furthermore, multiple types of RF noise generated from different real-world sources—such as streetlights, desk lamps, industrial machinery, and household appliances—were also characterized and introduced into the network. The combination of multiple defective or impaired network components and various noise sources provides a comprehensive view of the network's condition and performance, resulting in a robust dataset that can be used for various experimental studies and research focused on network operations and maintenance.

In regard to lab setup, the HFC lab setup mirrors a real world RF network featuring fiber nodes, various models of CMTSs, various CPE, and other network components. To ensure immunity from external noise, cross-neighbor interference and to prevent noise emission, the modems are housed within shielded enclosures. Similarly, the impairments and noise sources, which are intended to serve as different network conditions, are also placed in shielded enclosures to isolate them from outside environmental noise. Further, a software application is employed to automatically control the network conditions, changes the network parameters and apply different noise sources while simultaneously collecting and labeling data.

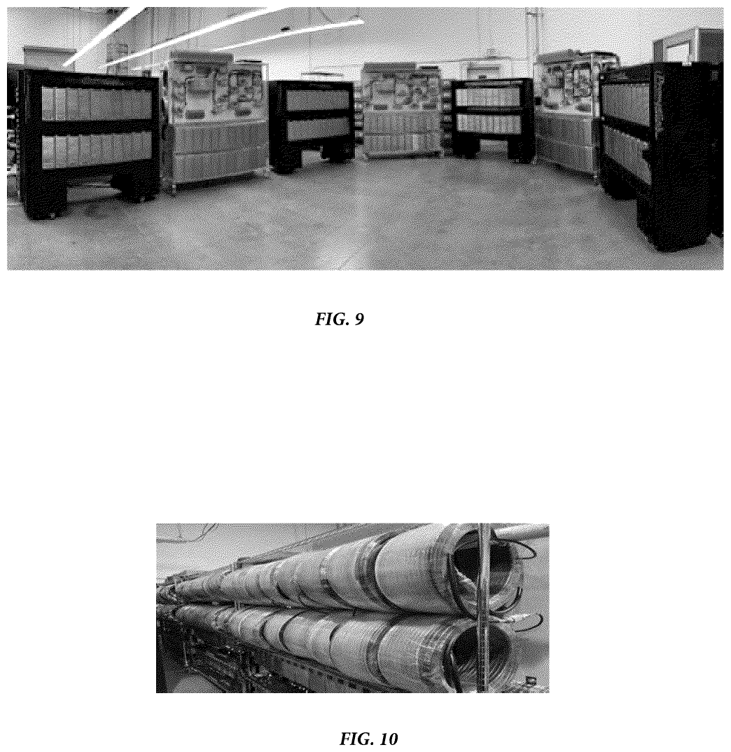

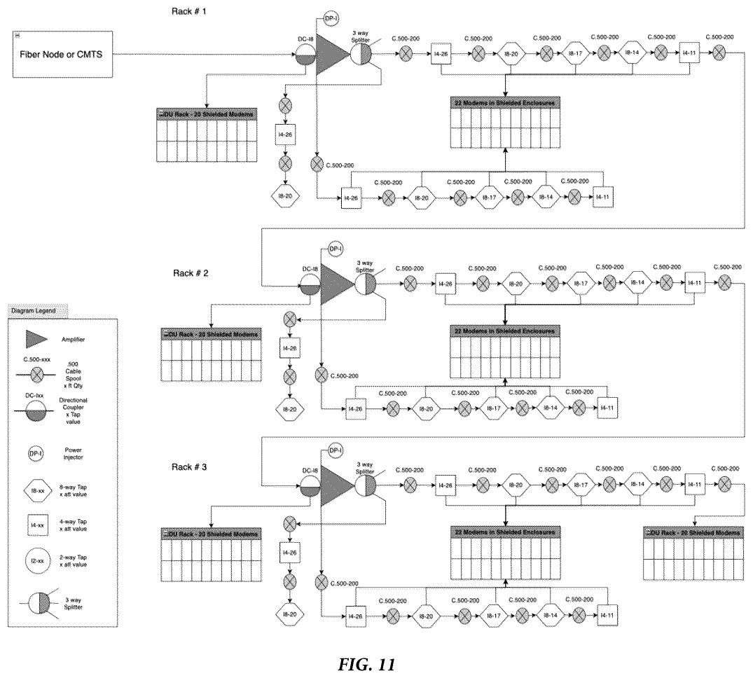

In regard to lab hardware configuration, from the image and the diagram shown in FIGS. 9-11, the lab setup comprises three network segments, each equipped with an amplifier and various passive components, including directional couplers, three-way splitters taps, power injectors, etc., all housed on a movable rack. Within each segment, there are 22 cable modems directly connected to taps via either 10-ft or 50-ft drop cables. Each tap is linked to two modems. Additionally, each segment is linked to a Multi Dwelling Unit (MDU) rack featuring a dedicated MDU amplifier and 20 modems at the end of the segment. An extra MDU rack is situated at the input of the first network segment.

These three network segments and four “MDUs” form a realistic N+4 cable plant topology, spanning from Near to Far and Farther/Farthest locations. On the left side of the photo, the first MDU rack is connected to the left of the “Near” network segment, while another MDU rack is connected to its right. This pattern repeats with the “Far” network segment in the center of the photo and again on the right with the “Farther/Farthest” network segment and a final MDU Rack. Modem in MDU1 are nearest to the Fiber Node (or the CMTS), likely only a few feet of coax away, while its' modems in MDU2 are about 1,200 feet further, and those in the Far-MDU3 and Farthest-MDU4 are 2,400 and 3,600 feet away, respectively.

Utilization of Faraday Cages for larger impairments and Shielded Enclosures for individual modems provides confinement and isolation of the unintended noise generated by each modem. This setup facilitates realistic simulation of noise impairments, including those from external sources like home appliances and industrial machinery, when there is a failed or impaired network component. Additionally, it ensures that intentionally generated noise, for the experimental study and research, affects (e.g., only affects) the intended area of the network, isolating it from other sections and their components.

To enhance the quality and usefulness of the data, other factors that may affect the results—such as the make and model of cable modems—are carefully considered. Different brands and models of modems can report varying values for power levels, SNR, or timing offset (a parameter that indicates how far a modem is located from the CMTS). To account for this, all racks are optionally meticulously configured to match one another. Similar or identical modems are positioned in corresponding spots within both the network segments and MDU racks, with specified and matching power levels. For instance, each of the four MDU racks' first slots contain identical modems with the same firmware, all configured to have matching power levels. Although the modems in other slots differ from those in the first slot of each MDU rack, consistency is maintained across the same slot in different racks.

This approach enables the captured data to be used for studying timing offset variations across different parameters related to cable modems, including modem types at four different distances. Furthermore, when impaired components and noise are introduced at various network locations, the effects on telemetry data, including timing offsets, can be captured. This comprehensive dataset serves not only to study the impact of noise and impairments on network performance but also as data for automated prediction and extraction of the network topology. In this lab, the collected data includes all DOCSIS and PNM monitoring parameters, environmental factors such as temperature, and other network operational data, such as the amount of traffic passing through the network and each cable modem.

In regard to network conditions, the network conditions consist of two distinct parts. The first part is defined by one or more impaired network components placed at specific locations within the network, causing noise-like distortions or allowing external noise to enter. These impairments can also affect operational parameters, such as power levels or the frequency response of the transmission line connecting the modem to the CMTS. Additionally, noise sources may be present and emit different types of noise into the environment surrounding the network, which can potentially enter the network due to faults or failures in the impaired components.

The second part involves the brand and locations of the modems used in data collection. The lab setup ensures that data is collected not only based on network conditions and the location of impaired components—such as the source of network-originated noise—but also tracks the distance of the modems from the CMTS, as well as their make and model. This information is valuable for research related to DOCSIS timing offsets and their validation under different network conditions and modem types, supporting automated extraction of network topology in the field.

There are three main objectives for network condition characterization. First, to identify the parameters that describe the characteristics of network conditions, specifically the noise type and the type of impaired network component. Second, to test, characterize, and catalog a wide range of noise sources (noise types) and real-world impaired network components for use in lab networks. Third, to differentiate between various brands, models, and firmware of cable modems and CMTSs, and to compile calibration data for operational parameters such as power levels, Signal-to-Noise Ratio (SNR), noise spectral density, and other metrics reported by these devices.

Faults and failures in cable networks can occur in various forms, with the most common including physical or water damage to cables and connectors, as well as damage to passive or active network components. The use of simple descriptive labels, such as “loose connector”, is not straightforward because a label like “Loose Connector” could refer to multiple conditions, including the type of cable, the type of connector, and the degree of looseness. Therefore, it is necessary to develop and use a parametric model that can describe the different conditions of an impaired network component in detail. Moreover, it is helpful to measure and document these parameters across multiple real-world impairments. It is helpful to maintain the condition of the impairment in controlled form during the data collection as it is a key factor of data consistency and integrity.

A suitable model for characterizing impaired network components is the transmission line model that utilizes S-parameters. By using S-parameters, the model can accurately characterize the behavior of the impaired component as a transmission line. In this case, since our aim is to characterize the impaired components for use in data labeling for noise and leakage localization, it is helpful to take into account signal leakage and ingress in addition to signal transmission and reflections. Therefore, the model can be for a 3-port transmission line, as in FIG. 1B1.

In this model, parameters S21 and S12 describe the signal transmission and reflection, while the parameter S31 describes signal leakage and ingress. Promptlink's Impaired Component Characterization Lab (PICCL) is equipped with advanced test and measurement instruments as well as software applications for measuring and cataloging the characteristics of different types of fault and failures in network components used in HFC networks. Measuring the S-parameters to characterize the real-world impaired components taken from the field and cataloging them for use in a data labeling setup is performed at an Impairment Characterization Lab. Keeping track of S-parameters overtime for each individual impairment plays an important role in consistency and integrity of the collected data.

Examples of different types of impaired network components include a hardline coaxial cable with loose splice connector and an in-home corroded power splitter. For the hardline coaxial cable with loose splice connector, FIG. 2B2, described in further detail above, shows examples of S21 and S31 of a hardline coaxial cable with a broken radial shield (100 f. of cable on each side) over a frequency range of 5 MHz to 100 MHz. For the in-home corroded power splitter, FIG. 2B3, as described in further detail above, illustrates examples of S21 and S31 of a corroded in-home connector (100 ft of cable on each side) over a frequency range of 5 MHz to 100 MHz. Other S parameters are also contributing to the characterization of the impaired network component in FIG. 2B3. These parameters are optionally being measured and documented as well.

In real world conditions, RF noise originates from diverse sources such as household appliances, industrial machinery, and lighting, each exhibiting unique noise characteristics or signatures. These characteristics can vary widely, including impulse noise, white noise, and noise that is more pronounced at specific frequencies. The nature of noise may be steady, fluctuate over time, or occur sporadically. In the context of studying noise effects, detection, identification, and localization, accurate characterization of different types of noise is important, requiring the use of parametric models. Generic descriptions, such as “noise from a desk lamp,” are insufficient due to the significant variation in noise signatures, even among similar items. Therefore, the emphasis in data collection is on capturing specific noise signatures rather than relying on general descriptions.

Some noise models have limited spectral awareness, assume stationarity, can't capture fluctuation speed or irregularity, are based on idealized random processes and not actual RTSA (Real Time Spectrum Analyzer) or FFT (Fast Fourier Transform) measurements, and/or output scalar statistics rather than structured spectro-temporal features that can be easily measured and analyzed. A suitable model for noise characterization, particularly for this experimental setup and data collection, as well as for applications like training machine learning models for noise localization, involves using statistical parameters across different frequency bands of the noise spectrum. This is important because the noise spectrum can either dynamically change or remain static over time, depending on the frequency band. In this model, the defining parameters include the maximum, minimum, and mean noise spectrum, as well as the standard deviation of noise power at different frequencies.

For this noise characterization model, the noise spectrum is divided into many small frequency bins. For each bin, the time-varying noise power is analyzed to extract key statistics using various parameters, including μ(f), σ(f), D(f), and σ_{D}(f). For example, μ(f) is the average or mean noise power. For example, σ(f) indicates fluctuation magnitude, such as how much power varies (amplitude of fluctuation). While σ(f) describes how large the power variations are, it does not describe how fast power variations change. The two additional parameters, D(f) and σ_{D}(f), can be used to indicate the rate of change for each frequency bin and the irregularity of that rate of change. These parameters (μ(f), σ(f), D(f), and σ_{D}(f)) form a spectro-temporal map that describes where the noise occurs (in frequency) and how it behaves (over time). The model captures both the spectral and temporal characteristics, thereby creating a more complete characterization of noise behavior.

The magnitude spectrum of a signal, S(f), is observed in the frequency and time domains, being a discrete signal denoted as S[fᵢ, k], where fᵢ is the discrete frequency and k is the discrete time index (for N total samples, k=1, 2, . . . , N). Statistical metrics are calculated over the N time samples for each frequency fᵢ.

The mean and variability metrics describe the central value and the dispersion of the spectral power at a given frequency. The mean rate of change and rate variability metrics describe the average speed and irregularity with which the power fluctuates over time, and we assume a temporal sampling interval Δt.

For example, mean power (μ(fᵢ) represents the average energy at frequency fᵢ:

$$μ ( {f}_{i} ) = \frac{1}{N} {\sum }_{k = 1}^{N} S [ {f}_{i} , k ]$$

For example, power variability σ(fᵢ) represents the standard deviation, measuring the strength of the power fluctuations around the mean:

$$σ ( {f}_{i} ) = \sqrt{\frac{1}{N - 1} {\sum }_{k = 1}^{N} {( S [ {f}_{i} , k ] - μ ( {f}_{i} ) )}^{2}}$$

For example, mean rate of change D(fᵢ) is calculated as the average of the first-order finite difference (the discrete analogue of the temporal derivative):

$$Δ S [ {f}_{i} , k ] = \frac{S [ {f}_{i} , k + 1 ] - S [ {f}_{i} , k ]}{Δ t}$$

$$D ( {f}_{i} ) = \frac{1}{N - 1} {\sum }_{k = 1}^{N - 1} Δ S [ {f}_{i} , k ]$$

For example, rate variability σD(fᵢ) represents the standard deviation of the rate of change, measuring how irregularly the power varies:

$${σ}_{D} ( {f}_{i} ) = \sqrt{\frac{1}{N - 2} {\sum }_{k = 1}^{N - 1} {( Δ S [ {f}_{i} , k ] - D ( {f}_{i} ) )}^{2}}$$

This noise characterization model works well for characterizing noise and for machine learning and artificial intelligence (AI) implementations. For example, the noise model converts real RTSA/FFT measurements into structured numerical features, produces multi-dimensional data instead of simple averages, works directly on measured signals without the need for assumptions about underlying distributions, creates feature maps ideal for machine learning and deep-learning models, and/or enables AI models to (a) recognize different noise types, identify where noise is generated or enters the network, and/or detect the type of impairments in network components (physical damage, water damage, etc.) causing or allowing noise to enter.

FIGS. 2C1-2C2 illustrate a noise spectrum max, mean, and minimum, as well as standard deviation at different frequencies for a noisy LED light, as described in greater detail above. FIGS. 2C5-2C6 illustrate the mean temporal rate of change and the variability of the rate of change for the same noisy LED light, as described in greater detail above. FIGS. 2C3-2C4 illustrate a noise spectrum max, mean, and minimum, as well as standard deviation at different frequencies for a second (different) noisy LED light, as described in greater detail above. FIGS. 2C7-2C8 illustrate the mean temporal rate of change and the variability of the rate of change for the second noisy LED light, as described in greater detail above.

MER and Power Level Calibration for Noise Spectral Density. Power levels and Modulation Error Ratio (MER) are important parameters for both network operations and HFC network topology analysis. By utilizing these parameters, it is possible to derive Noise Spectral Density (NSD) across different network segments, offering key insights into the origins of noise within the network. However, a major challenge arises due to the complex, non-linear relationships between NSD, power level, and MER, which vary across different modem brands, models, hardware versions, and firmware. To address this, a comprehensive test and measurement setup (MER/Power Level Calibration Lab) is employed to generate calibration tables for the MER and power levels of various modems.

Data Collection Software Application. Data collection is done is performed using SNMP polling engine and bulk data transfer specified in DOCSIS specification to collect all possible telemetry data from the network components and other monitoring tools including and not limited to, DOCSIS telemetry data, pre-equalization coefficients, upstream spectrum, Downstream Full Band Spectrum Capture (FBC), OFDM and OFDMA parameters such as subcarrier power levels, and RxMER, and channel with. downstream and upstream channel plans.

User Input. The technique provides an interface for users to input the following. Location ID: The application accepts a Location ID, which consists of two components: the network component ID (e.g., Amplifier A102) and an identifier specifying the exact location within the component where a fault or impairment could occur (e.g., P132). Impairment ID: The application provides a dropdown list for users to select an Impairment ID, imported from the source configuration file or table. Comment Field: Users are able to specify the comment that describes the data set that is about to be taken

Settings. The technique provides a settings page that allows it to read from four predefined tables: Impairment Type Code, Noise Source Code, Time Table, and Power Distribution Units (PDUs). These settings are imported from either tables or files: impairment types, noise sources, time table, PDUs. Users can select the CMTS IP address and specify the list of upstreams to inform the application which data to extract.

Users can also specify PDU details, which are provided through the PDU table or file, including the PDU ID (1, 2, etc.), the predefined PDU model name, the PDU IP address, and login credentials (username/password). The technique can use more than one PDU, with each assigned a unique PDU ID starting from 1. The relationship between the Noise Source and the PDU ID will be defined in the Noise Source table or file.

Data Recording. Upon starting the execution of the technique/application: (1) a record is created in the database, storing the start time, the selected Impairment ID, and the Location ID, (2) the application communicates with the PDU and ensures all its ports are off (No Noise), (3), the application follows a Baseline Time Period (BTP), set on the settings page, during which no noise is introduced, and data is collected, (4) once the BTP has ended, the application follows the pattern defined in the Time Table to toggle the PDU ports on or off, thereby introducing different noise levels, and (5) each time a PDU port is toggled (on/off), the application creates a new record in the database indicating the noise status (on/off). This process continues until all entries in the Time Table have been executed. In some embodiments, the order of the operations above can change and some operations may be omitted.

Data Collection. At the end of the time table execution, data for one location, one impairment and one noise source would have been collected. The application then continues to the next noise source by toggling the next port of the PDU and following the time table again. This process optionally continues until all noise sources have been used.

Program/technique termination. Upon completion of all noise sources, the program/technique optionally stops, allowing the user to change the Impairment ID and/or the Location ID to restart the program.

Data Management/API. The application/technique provides access to the database records through an API. This includes timestamps, Impairment Code, Location Code, Noise Code, on/off status, and start/end timestamps. Additionally, it provides information about the CMTS, its settings, and the upstream/downstream channel plan, as well as details about the different cable modems used in the network for data collection.

Control over the selection of impairment. The application/technique sends a command to two RF Coax switches to select one from multiple impaired network components (or impairments), already attached to the ports of the two RF Coax switches. Different impaired components (or impairments) are connected between the corresponding ports of switch one and switch two. For example, impairment one is connected between port one of switch one and port one of switch two. The common ports of switch one and switch two are the two end points of the impairments inserted into the network at different locations, where we intend to introduce the impairments.

Control over the strength of the noise generated by different noise sources. To achieve controllable noise levels, all noise sources will be placed in a Faraday cage. One or more antennas will capture the noise from the Faraday cage and transmit it through a cable to one or more antennas in another Faraday cage, where the impairments are located. The noise levels (range of attenuation) will be sourced from a table or file, with the noise sources defined in a noise sources catalog. In this catalog, each noise source will have its own specified noise level range. In some cases, the noise source may not emit noise at a strong enough level, so the attenuation for this source can differ from that of a source with stronger emissions. The noise level in the cable will be controlled by a programmable RF attenuator.

Control over network traffic level. The application controls network traffic levels, allowing multiple traffic levels to be generated. Collecting data at different traffic levels is important because traffic levels can affect modem responsiveness and, in some cases, lead to packet loss. Traffic may also impact telemetry parameters, such as timing offsets, or result in codeword errors. The traffic levels used in this application are sourced from a table or file, similar to those used for cataloging noise sources or impairments.

Lab Digital Twin Front-End Software Application and/or User Interface. The user of the HFC Lab Digital Twin can set up an experiment by selecting the parameters and data to be collected, just as they would in a real lab environment. However, instead of generating new data, the results of the experiment are drawn from a comprehensive dataset that has been previously collected and is available to the user. This approach allows the user to simulate real-world scenarios and analyze outcomes based on pre-existing data, offering a faster and more flexible method of experimentation.

The Lab Digital Twin enables the user to: (a) Configure the experiment setup by selecting network components, parameters, and conditions, (b) Choose specific data points, such as DOCSIS telemetry, spectrum captures, or subcarrier levels, to be analyzed, (c) Access experiment results, which are presented in a user-friendly format and can be exported for further analysis, (d) Modify experiment parameters and re-run simulations without the need for additional physical testing.

Experiment Setup. The user is presented with a logical diagram of the network, similar to FIGS. 1, 5A-5C, and/or 11. The user selects (and the technique receives) a location (or Point of Interest) on the network. These locations include inputs, outputs, and other connectors, as well as the faceplates of active and passive components. Each location's name is composed of the component's name (e.g., amplifiers, taps, directional couplers) and a specific location name associated with that component. Locations can also include individual modems. The user selects (and the technique receives) an impairment or an impaired component for the selected location from a dropdown list. The types of locations selected beforehand determine the types of impairments or impaired components available. The user selects (and the technique receives) a noise type (or noise source) from a dropdown list. The user selects (and the technique receives) the noise strength level from a dropdown menu. The options are: strong, medium-strong, medium, medium-low, and low. The user selects (and the technique receives) network traffic for upstream and downstream separately from a dropdown menu. The traffic levels listed are those used by the software application during data collection. The user can select (and the technique receives) the ambient temperature range from a list of measured temperature ranges in the collected data database. The user selects (and the technique receives) the number of tests to be conducted under the network condition selected above. The user selects (and the technique receives) the modems from the logical diagram to be used for data collection.

Experiment Parameters and Data Setup. The user selects (and the technique receives) parameters available from the CMTS through a dropdown list, which includes DOCSIS telemetry data, OFDMA subcarrier levels and RxMER, upstream spectrum, and pre-equalization coefficients, etc. The user selects (and the technique receives) parameters available from the cable modem through a dropdown list, which includes DOCSIS telemetry data, OFDM subcarrier levels and RxMER, downstream full-band spectrum capture, and more.

Experiment Execution. The user submits (and the technique receives) a request to run the experiment. The user has the option to modify the network conditions or the number of tests and re-run the experiment.

Results Reporting. The experiment results are optionally presented to the user in the form of one or multiple tables, depending on the data collected. These tables include key metrics and measurements from the experiment, organized for easy interpretation. The user has the option to export these tables to various formats, such as text files, Excel sheets, or Google Sheets, for further analysis or sharing. Additionally, the results can be visualized through graphs or charts directly in the interface, offering a more intuitive understanding of the data trends.

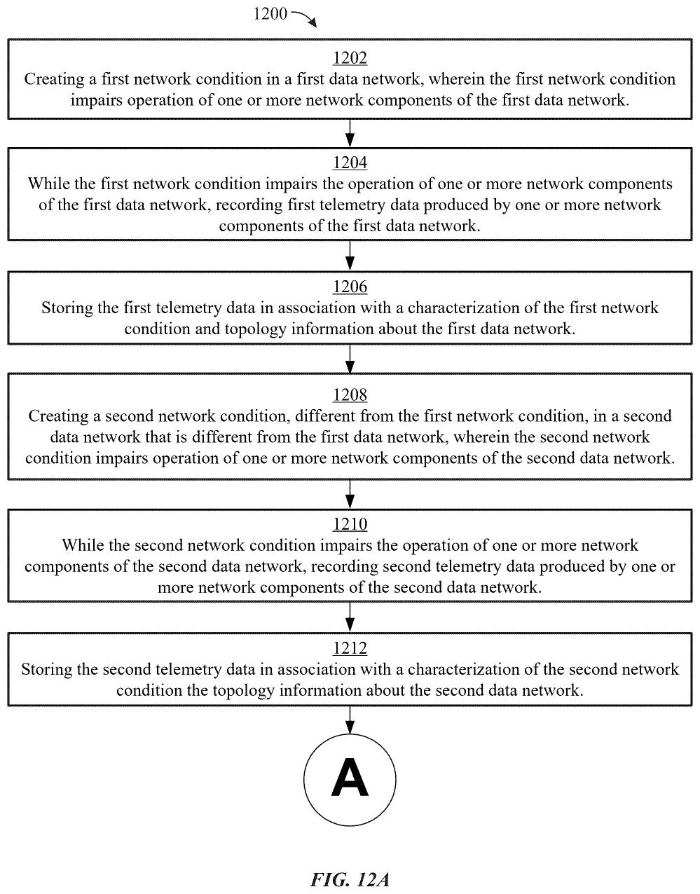

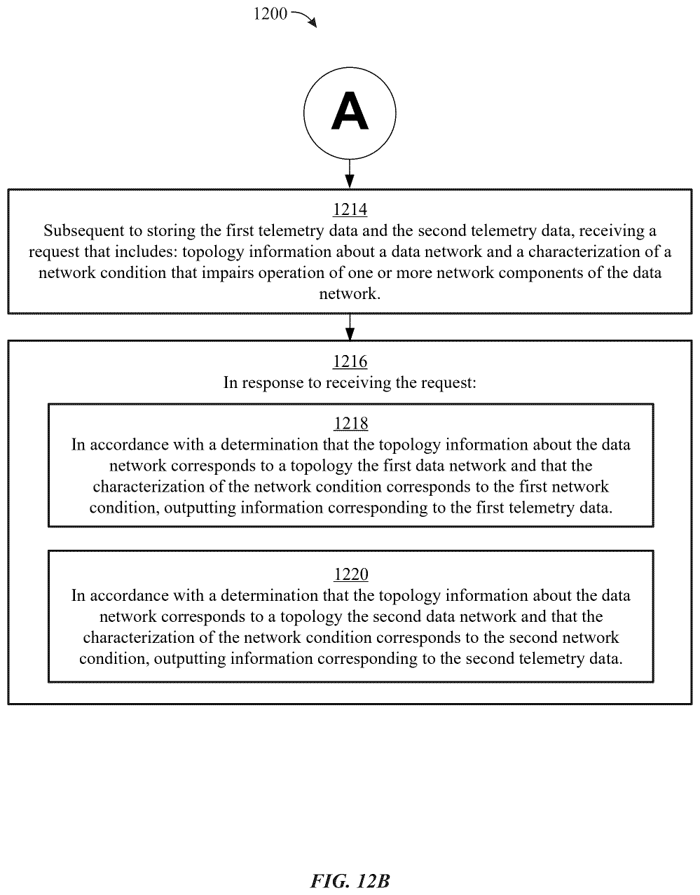

FIGS. 12A-12B is a flow diagram illustrating method 1200 for storing and retrieving network information, such as by using a computer system, in accordance with some embodiments. Method 1200 is optionally fully or partially performed at a computer system (e.g., with one or more processors and memory storing instructions for performing the method). Some operations in method 800 are, optionally, combined, the orders of some operations are, optionally, changed, and some operations are, optionally, omitted. Method 1200 is optionally stored in non-transitory memory in the form of computer-readable and executable instructions.

The technique includes creating (1202) a first network condition (e.g., impairing a network component, adding an impaired network component, and/or introducing noise) in a first data network (e.g., a data network formed in a lab environment for testing and/or analysis purposes), wherein the first network condition impairs operation of one or more network components (e.g., a cable modem, a splitter, and/or a coax cable) of the first data network.

The technique includes, while the first network condition impairs the operation of one or more network components of the first data network, recording (1204) first telemetry data produced by one or more (e.g., a plurality of) network components (e.g., one or more network components that have impaired operation due to the first network condition and/or one or more network components that do not have impaired operation due to the first network condition) of the first data network.

The technique includes storing (1206) (e.g., in a first database and/or in a first computer memory) the first telemetry data in association with a characterization of the first network condition and topology information about the first data network (e.g., without associating the first telemetry data with a characterization of a second network condition that is different from the first network condition and/or topology information about a second data network that is different from the first data network).

The technique includes creating (1208) a second network condition (e.g., impairing a network component, adding an impaired network component, and/or introducing noise), different from the first network condition, in a second data network (e.g., a data network formed in a lab environment for testing and/or analysis purposes) that is different from the first data network, wherein the second network condition impairs operation of one or more network components (e.g., a cable modem, a splitter, and/or a coax cable) of the second data network.

The technique includes, while the second network condition impairs the operation of one or more network components of the second data network, recording (1210) second telemetry data produced by one or more (e.g., a plurality of) network components (e.g., one or more network components that have impaired operation due to the first network condition and/or one or more network components that do not have impaired operation due to the first network condition) of the second data network.

The technique includes storing (1212) (e.g., in the first database and/or in the first computer memory) the second telemetry data in association with a characterization of the second network condition the topology information about the second data network (e.g., without associating the second telemetry data with a characterization of the first network condition that is different and/or topology information about the first data network).

The technique includes, subsequent to storing the first telemetry data and the second telemetry data, receiving (1214) (e.g., via user input at a local or remote computer terminal and/or via automated computer determination) a request that includes: topology information about (e.g., selection of) a data network, and a characterization of a network condition that impairs operation of one or more network components of the data network; and In some embodiments, the technique receives the topology information about the data network by receiving selection of different components from drop-down menus to insert/display into a visual representation of the data network. In some embodiments, the technique receives a characterization of the network condition by displaying a dropdown menu of options and receiving a selection of a particular network condition from among the options of the dropdown menu.

The technique includes, in response (1216) to receiving the request and in accordance with a determination that the topology information about the data network corresponds to a topology the first data network (e.g., using the topology information about the first data network, such as by the topology information about the data network corresponding to and/or matching the topology information about the first data network) and that the characterization of the network condition corresponds to the first network condition (e.g., using the characterization of the first network condition, such as by the characterization of the first network condition corresponding to and/or matching the characterization of the network condition), outputting (1218) (e.g., displaying via a display and/or transmitting via a network) information (e.g., the stored telemetry information about the first data network, information previously collected about the first data network, and/or information about an experiment/test performed using the first data network) corresponding to the first telemetry data (e.g., retrieved from the first database and/or the first computer memory) (e.g., without outputting information corresponding to the second telemetry data and/or other telemetry data).

The technique includes, in response (1216) to receiving the request and in accordance with a determination that the topology information about the data network corresponds to a topology the second data network (e.g., using the topology information about the second data network, such as by the topology information about the data network corresponding to and/or matching the topology information about the second data network) and that the characterization of the network condition corresponds to the second network condition (e.g., using the characterization of the second network condition, such as by the characterization of the second network condition corresponding to and/or matching the characterization of the network condition), outputting (1220) (e.g., displaying via a display and/or transmitting via a network) information (e.g., the stored telemetry information about the second data network, information previously collected about the second data network, and/or information about an experiment/test performed using the second data network) corresponding to the second telemetry data (e.g., retrieved from the first database and/or the first computer memory) (e.g., without outputting information corresponding to the first telemetry data and/or other telemetry data). In some embodiments, the technique trains (e.g., before receiving the request) one or more machine learning models using the first telemetry data in association with the characterization of the first network condition and the topology information about the first data network and using the second telemetry data in association with the characterization of the second network condition and the topology information about the second data network. In some embodiments, respective topology information is stored using a structured data storage technique, such as JavaScript Object Notation (JSON), YAML, or XML.

In some embodiments, creating the first network condition in the first data network comprises including a first impaired network component. In some embodiments, examples of an impaired network component include network components with physical damage, with water damage, that have fiber node misalignment, that have amplifier misalignment; and/or are in-home impaired network components. In some embodiments, creating the first network condition in the first data network comprises submersing at least a portion of a respective network component in water. In some embodiments, creating the second network condition in the second data network comprises including a second impaired network component that is different from the first impaired network component.

In some embodiments, characterizing the first impaired network component using a transmission line model to determine a characterization of the first impaired network component, wherein the characterization of the first network condition is based on (e.g., uses and/or is the same as) the characterization of the first impaired network component. In some embodiments, a respective impaired network component is characterized while the respective impaired network component is not part of the first data network. In some embodiments, impaired network components are characterized using a transmission line model to determine a characterization of the impaired network component and a respective characterization of the network condition is based on (e.g., uses and/or is the same as) the characterization of the impaired network component.

In some embodiments, creating the first network condition in the first data network comprises introducing first noise (e.g., generated by a noise source) into the first data network. In some embodiments, examples of noise sources that introduce noise into a data network include: household appliances, LED lights in the environment of the data network, and RF transmitters in the environment of the data network. In some embodiments, creating the second network condition in the second data network comprises introducing second noise (e.g., generated by a noise source) into the second data network.

In some embodiments, characterizing the first noise using statistical parameters for different frequency bands of the first noise (e.g., the maximum spectrum of noise, the minimum spectrum of noise, the mean spectrum of noise, and/or the standard deviation of noise power at different (e.g., a plurality of) frequencies) to determine a characterization of the first noise, wherein the characterization of the first network condition is based on (e.g., uses and/or is the same as) the characterization of the first noise. In some embodiments, a respective noise and/or noise source is characterized independent of the first data network. In some embodiments, the technique includes characterizing respective noise using statistical parameters for different frequency bands of the respective noise (e.g., the maximum spectrum of the respective noise, the minimum spectrum of the respective noise, the mean spectrum of the respective noise, and/or the standard deviation of the respective noise power at different (e.g., a plurality of) frequencies) to determine a characterization of the respective noise, wherein the characterization of a respective network condition is based on (e.g., uses and/or is the same as) the characterization of the respective noise.

In some embodiments, characterizing the first noise to determine the characterization of the first noise includes determining (e.g., for a plurality of frequencies) a mean power (e.g., μ(fᵢ) that represents the average energy at frequency fᵢ), power variability (e.g., σ(fᵢ) that represents the standard deviation, measuring the strength of the power fluctuations around the mean), mean rate of change, (e.g., D(fᵢ) that is optionally calculated as the average of the first-order finite difference (the discrete analogue of the temporal derivative)), and/or rate variability (e.g., σ_{D}(fᵢ) that represents the standard deviation of the rate of change, measuring how irregularly the power varies).

In some embodiments, recording topology information about a respective data network (e.g., the first data network and/or the second data network) comprises recording a make, a model, and/or a version (e.g., a software version and/or a firmware version) of (e.g., of all or less than all) network components (e.g., one or more network components that have impaired operation due to a network condition and/or one or more network components that do not have impaired operation due to a network condition) of the respective data network.

In some embodiments, recording topology information about a respective data network (e.g., the first data network and/or the second data network) comprises recording locations (e.g., relative to other network components and/or absolute locations) of (e.g., of all or less than all) network components of the respective data network. In some embodiments, recording topology information about the respective data network comprises recording information about how network components of the respective data network are interconnected.

In some embodiments, recording topology information about a respective data network (e.g., the first data network and/or the second data network) comprises recording cable distances (e.g., in meters and/or in miles) between network components of the respective data network. In some embodiments, recording topology information about the respective data network comprises recording information about how network components of the respective data network are interconnected.

In some embodiments, the technique includes: creating a third network condition (e.g., impairing a network component, adding an impaired network component, and/or introducing noise), different from the first network condition, in the first data network (e.g., in addition to or without the first network condition), wherein the third network condition impairs operation of one or more network components (e.g., a cable modem, a splitter, and/or a coax cable) of the first data network. In some embodiments, the third network condition is the same as the second network condition. The technique includes, while the third network condition impairs the operation of one or more network components of the first data network, recording third telemetry data produced by one or more (e.g., a plurality of) network components (e.g., one or more network components that have impaired operation due to the first network condition and/or one or more network components that do not have impaired operation due to the first network condition) of the first data network. The technique includes storing (e.g., in a first database and/or in a first computer memory) the third telemetry data in association with a characterization of the third network condition and topology information about the first data network (e.g., without associating the third telemetry data with a characterization of the first or second network conditions that are different from the third network condition and/or topology information about the second data network that is different from the first data network). The technique includes, in response (1216) to receiving the request and in accordance with a determination that the topology information about the data network corresponds to a topology the first data network (e.g., using the topology information about the first data network, such as by the topology information about the data network corresponding to and/or matching the topology information about the first data network) and that the characterization of the network condition corresponds to the third network condition (e.g., using the characterization of the third network condition, such as by the characterization of the third network condition corresponding to and/or matching the characterization of the network condition), outputting (e.g., displaying via a display and/or transmitting via a network) information (e.g., the stored telemetry information about the first data network, information previously collected about the first data network, and/or information about an experiment/test performed using the first data network) corresponding to the third telemetry data (e.g., retrieved from the first database and/or the first computer memory) (e.g., without outputting information corresponding to the first, second, or other telemetry data). In some embodiments, the technique includes, in response (1216) to receiving the request and in accordance with a determination that the topology information about the data network does not correspond to an existing network topology and/or that the characterization of the network condition dees not correspond to an existing network condition, initiating a process to perform an in-lab experiment with the requested network topology and the requested network condition (e.g., without outputting information corresponding to telemetry data).

In some embodiments, the request includes selection (e.g., user selection from a drop-down menu) of one or more parameters and/or data; and outputting information corresponding to a respective (e.g., first, second, or third) telemetry data includes outputting information corresponding to the selected one or more parameters and/or data. In some embodiments, the data includes specific data points within the network for which information (such as DOCSIS telemetry, spectrum captures, or subcarrier levels) should be output.

In some embodiments, the technique stores telemetry data produced by a plurality of network components of a deployed data network (e.g., that is operating with active users) (e.g., different from the first and second data networks), stores topology information about the deployed data network (e.g., wherein the topology information is generated based on the telemetry data and/or based on records of the data network), associates the telemetry data produced by the plurality of network components of the deployed data network with the topology information about the deployed data network, and uses one or more machine learning models (e.g., that were training using the first telemetry data, the second telemetry data, and/or the third telemetry data) to determine one or more characteristics of a network condition (e.g., an impaired network component and/or noise) in the deployed data network. In some embodiments, the one or more characteristics includes a location of noise entering the deployed data network and/or a location of an impaired network component in the deployed data network. In some embodiments, the one or more characteristics includes a type, make, model, and/or version of an impaired network component in the deployed data network. In some embodiments, the one or more characteristics includes a type of noise entering the deployed data network.

The techniques described above with respect to FIGS. 12A-12B can be combined with aspects of the technique described above with respect to FIG. 8. Some steps of technique 1200 can be omitted and/or the order of the steps can be changed.

The foregoing description has been described with reference to specific embodiments. However, the illustrative discussions above are not intended to be exhaustive or to limit the invention to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, it is to be noted that various changes and modifications will become apparent to those skilled in the art. Such changes and modifications are to be understood as being included within the scope of the disclosure.

What is claimed is:

1. A method, comprising:
creating a first network condition in a first data network, wherein the first network condition impairs operation of one or more network components of the first data network;
while the first network condition impairs the operation of one or more network components of the first data network, recording first telemetry data produced by one or more network components of the first data network;
storing the first telemetry data in association with a characterization of the first network condition and topology information about the first data network;
creating a second network condition, different from the first network condition, in a second data network that is different from the first data network, wherein the second network condition impairs operation of one or more network components of the second data network;
while the second network condition impairs the operation of one or more network components of the second data network, recording second telemetry data produced by one or more network components of the second data network;
storing the second telemetry data in association with a characterization of the second network condition the topology information about the second data network;
subsequent to storing the first telemetry data and the second telemetry data, receiving a request that includes:
topology information about a data network, and
a characterization of a network condition that impairs operation of one or more network components of the data network; and
in response to receiving the request:
in accordance with a determination that the topology information about the data network corresponds to a topology the first data network and that the characterization of the network condition corresponds to the first network condition, outputting information corresponding to the first telemetry data; and
in accordance with a determination that the topology information about the data network corresponds to a topology the second data network and that the characterization of the network condition corresponds to the second network condition, outputting information corresponding to the second telemetry data.

2. The method of claim 1, wherein creating the first network condition in the first data network comprises including a first impaired network component.

3. The method of claim 2, further comprising:
characterizing the first impaired network component using a transmission line model to determine a characterization of the first impaired network component, wherein the characterization of the first network condition is based on the characterization of the first impaired network component.

4. The method of claim 1, wherein creating the first network condition in the first data network comprises introducing first noise into the first data network.

5. The method of claim 4, further comprising:
characterizing the first noise using statistical parameters for different frequency bands of the first noise to determine a characterization of the first noise, wherein the characterization of the first network condition is based on the characterization of the first noise.

6. The method of claim 5, wherein characterizing the first noise to determine the characterization of the first noise includes determining mean power, power variability, mean rate of change, and rate variability.

7. The method of claim 1, wherein recording topology information about a respective data network comprises recording a make, a model, and/or a version of network components of the respective data network.

8. The method of claim 1, wherein recording topology information about a respective data network comprises recording locations of network components of the respective data network.

9. The method of claim 1, wherein recording topology information about a respective data network comprises recording cable distances between network components of the respective data network.

10. The method of claim 1, further comprising:
creating a third network condition, different from the first network condition, in the first data network, wherein the third network condition impairs operation of one or more network components of the first data network;
while the third network condition impairs the operation of one or more network components of the first data network, recording third telemetry data produced by one or more network components of the first data network;
storing the third telemetry data in association with a characterization of the third network condition and topology information about the first data network; and
in response to receiving the request:
in accordance with a determination that the topology information about the data network corresponds to a topology the first data network and that the characterization of the network condition corresponds to the third network condition, outputting information corresponding to the third telemetry data.

11. The method of claim 1, wherein:
the request includes selection of one or more parameters and/or data; and
outputting information corresponding to a respective telemetry data includes outputting information corresponding to the selected one or more parameters and/or data.

12. A non-transitory computer-readable storage medium storing one or more programs configured to be executed by one or more processors, the one or more programs including instructions for:
creating a first network condition in a first data network, wherein the first network condition impairs operation of one or more network components of the first data network;
while the first network condition impairs the operation of one or more network components of the first data network, recording first telemetry data produced by one or more network components of the first data network;
storing the first telemetry data in association with a characterization of the first network condition and topology information about the first data network;
creating a second network condition, different from the first network condition, in a second data network that is different from the first data network, wherein the second network condition impairs operation of one or more network components of the second data network;
while the second network condition impairs the operation of one or more network components of the second data network, recording second telemetry data produced by one or more network components of the second data network;
storing the second telemetry data in association with a characterization of the second network condition the topology information about the second data network;
subsequent to storing the first telemetry data and the second telemetry data, receiving a request that includes:
topology information about a data network, and
a characterization of a network condition that impairs operation of one or more network components of the data network; and
in response to receiving the request:
in accordance with a determination that the topology information about the data network corresponds to a topology the first data network and that the characterization of the network condition corresponds to the first network condition, outputting information corresponding to the first telemetry data; and
in accordance with a determination that the topology information about the data network corresponds to a topology the second data network and that the characterization of the network condition corresponds to the second network condition, outputting information corresponding to the second telemetry data.

13. The non-transitory computer-readable storage medium of claim 12, wherein creating the first network condition in the first data network comprises including a first impaired network component.

14. The non-transitory computer-readable storage medium of claim 13, the one or more programs including instructions for:
characterizing the first impaired network component using a transmission line model to determine a characterization of the first impaired network component, wherein the characterization of the first network condition is based on the characterization of the first impaired network component.

15. The non-transitory computer-readable storage medium of claim 12, wherein creating the first network condition in the first data network comprises introducing first noise into the first data network.

16. The non-transitory computer-readable storage medium of claim 15, the one or more programs including instructions for:
characterizing the first noise using statistical parameters for different frequency bands of the first noise to determine a characterization of the first noise, wherein the characterization of the first network condition is based on the characterization of the first noise.

17. The non-transitory computer-readable storage medium of claim 16, wherein characterizing the first noise to determine the characterization of the first noise includes determining mean power, power variability, mean rate of change, and rate variability.

18. The non-transitory computer-readable storage medium of claim 12, wherein recording topology information about a respective data network comprises recording a make, a model, and/or a version of network components of the respective data network.

19. The non-transitory computer-readable storage medium of claim 12, wherein recording topology information about a respective data network comprises recording locations of network components of the respective data network.

20. The non-transitory computer-readable storage medium of claim 12, wherein recording topology information about a respective data network comprises recording cable distances between network components of the respective data network.

21. The non-transitory computer-readable storage medium of claim 12, the one or more programs including instructions for:
creating a third network condition, different from the first network condition, in the first data network, wherein the third network condition impairs operation of one or more network components of the first data network;
while the third network condition impairs the operation of one or more network components of the first data network, recording third telemetry data produced by one or more network components of the first data network;
storing the third telemetry data in association with a characterization of the third network condition and topology information about the first data network; and
in response to receiving the request:
in accordance with a determination that the topology information about the data network corresponds to a topology the first data network and that the characterization of the network condition corresponds to the third network condition, outputting information corresponding to the third telemetry data.

22. The non-transitory computer-readable storage medium of claim 12, wherein:
the request includes selection of one or more parameters and/or data; and
outputting information corresponding to a respective telemetry data includes outputting information corresponding to the selected one or more parameters and/or data.
